(19) United States
(12) Patent Application Publication
(10) Pub. No.: US 2026/0340006 A1
(43) Pub. Date: Oct. 29, 2026

(54) DATA DISTRIBUTION MANAGEMENT

(71) Applicant: Honeywell International Inc., Charlotte, NC (US)

(72) Inventors: ANKIT SINGH, Apex, NC (US); Lakshminarayana Paila, Frisco, TX (US)

(21) Appl. No.: 19/192,412

(22) Filed: Apr. 29, 2025

(51) Int. Cl. G06F 16/334; G06F 16/332; G06F 40/30

(52) U.S. Cl. CPC G06F 16/334; G06F 16/3326; G06F 40/30

(57) ABSTRACT

Techniques for managing distribution of data are disclosed. A query comprising an input descriptor is received. The input descriptor indicates a retrieval parameter for querying a data intelligence repository. Further, datasets available in the data intelligence repository are parsed to identify set of relevant data based on semantic or contextual inference. For the identified set of relevant data, an adaptive data segmentation workflow is executed to manage distribution of the relevant data among segments. The distribution is based on at least one of a computational data dimension threshold, semantic relationships data in the set of relevant data, and a historical data partitioning schema derived based on partitioning of data indicated by a set of records historically recorded. Further, a record generation signal indicating segments comprising data from the relevant set is generated.

### BACKGROUND

Organizations typically prepare various records or files. These records may include data, for example, product and service information, organizational progress updates, management reports, and other information or news. Such records are typically prepared manually by following multiple tedious operations that encounter several challenges, especially in incorporating complex and dynamic content which may vary considerably in aspects such as size, type, and format.

### BRIEF DESCRIPTION OF DRAWINGS

FIGS. 1A to 1C illustrate a block diagram of a computing environment comprising a system, according to an example implementation of the present subject matter.

FIG. 2A illustrates a block diagram of a data intelligence repository comprising a plurality of datasets, according to one example implementation of the present subject matter.

FIG. 2B illustrates a block diagram indicating probable interconnections between datasets, according to one example implementation of the present subject matter.

FIG. 3 illustrates a block diagram of the system, according to one example implementation of the present subject matter.

FIG. 4 illustrates a block diagram of a computing environment comprising the system, according to another example implementation of the present subject matter.

FIG. 5A illustrates a block diagram of an interactive interface, according to one example implementation of the present subject matter.

FIGS. 5B and 5C illustrate a block diagram of a graphical user interface comprising the interactive interface, according to one example implementation of the present subject matter.

FIG. 6 illustrates a block diagram of a graphical user interface comprising a record, according to one example implementation of the present subject matter.

FIGS. 7A and 7B illustrate a block diagram of an exemplary method for managing distribution of data, according to one example implementation of the present subject matter.

FIG. 8 illustrates a non-transitory computer-readable medium for managing distribution of data, in accordance with an example of the present subject matter.

Throughout the drawings, identical reference numbers designate similar, but not necessarily identical, elements. The figures are not necessarily scaled, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Generally, organizations prepare various records or files as part of their operational processes. Such records typically contain informational content designed to convey specific intents. This content may encompass a wide range of topics, including but not limited to product features, performance metrics, quality assessments, sales data, technical specifications, organizational progress, internal structural changes, management updates, and other news or data. For instance, review reports often serve as indicators of an organization's operational performance. The information may be presented in various formats, such as textual descriptions, images, tables, charts, graphs, templates, advertisements, or interactive dashboards.

The preparation of these records is traditionally a manual process that requires significant time and effort from one or more individuals. For example, subject matter experts from different departments may be involved in adding and updating content to create and finalize the record. While various tools and applications may be utilized as sources and instruments for content preparation, certain necessary operations, such as analysing, filtering, and incorporating relevant information into the record often require considerable manual intervention.

The manual approach to record preparation introduces several challenges. For example, such processes are time-consuming processes requiring individuals to sift through vast amounts of data, often stored across various databases or systems. As a result, the time required to prepare comprehensive data-driven records increases substantially. Moreover, the repeated access to multiple databases and tools, and the constant updating of document content can lead to inefficient use of computing resources. For example, individuals may repeatedly access databases to analyze and obtain content required for preparing the record. Once the content is obtained, the individuals may then initiate one or more tools or applications for modification and addition of content for the record. Such processes may typically be implemented multiple times when manually processing content for preparing the records. This inefficiency may manifest in increased processing time, higher resource consumption, and potential system slowdowns, especially when dealing with large volumes of data or complex document structures.

Further, the quality and accuracy of manually prepared records can vary significantly based on, for instance, the skill level and expertise of the individuals involved. Such variability may lead to inconsistencies in the quality of records across an organization, which may potentially impact, for instance, operational processes or external communications. Furthermore, manual record preparation may result in suboptimal space utilization within the record itself. Without automated tools to optimize layout and decide content placement, files or records may become unnecessarily lengthy or poorly structured, making them less effective in conveying information to the intended audience. Manual record preparation may thus lead to inefficient space utilization, inefficient layouts, and poor pagination. Moreover, larger documents require more storage space, leading to increased storage requirements, slower transmission times, increased processing time, and potential backup and recovery challenges.

Manual record preparation faces additional challenges due to the incorporation of varied or dynamic content. This dynamic content can vary considerably in aspects, for example, size, type, and format, encompassing elements like textual descriptions, images, tables, charts, graphs, templates, advertisements, and interactive dashboards. The variability and complexity of this content make manual record preparation more prone to errors and inconsistencies in layout and presentation.

Inefficient space utilization, inefficient layouts, and poor pagination may increase the length and size of records, and are thus common issues in manual record preparation, especially when dealing with dynamic content. Further, larger records require more storage space, leading to increased storage requirements, slower transmission times, increased processing time, and potential backup and recovery challenges. Existing solutions fail to optimize and intelligently split or manage data in record preparation. While some tools may offer basic formatting capabilities, they often lack the data-driven intelligence and ability to dynamically analyze content, recommend optimal data distribution or page breaks, and ensure consistent layout across different types of records and report structures.

The present subject matter describes approaches for the management of data distribution. In one example, the distribution of data may be managed to develop or prepare a machine-readable record efficiently.

According to one example of the present subject matter, a query comprising an input descriptor may be received. The input descriptor may indicate a retrieval parameter. The retrieval parameter may be, for example, information indicating an identifier, feature, characteristic, or nature of data that is intended to be retrieved to service the query. For example, a retrieval parameter like “2020 resource utilization by region” specifies a time period, performance metric, and geographical breakdown.

In one example, the retrieval parameter may be utilized for querying a data intelligence repository and retrieving data or datasets from the data intelligence repository. For instance, based on the retrieval parameter, datasets available in the data intelligence repository may be parsed to identify a set of relevant data conforming with the retrieval parameter. In one example, the data intelligence repository may be a comprehensive backend database prepared with a vast amount of information or datasets. In one example, the data intelligence repository may comprise information or datasets consolidated for an organization or multiple interlinked or similar organizations. The datasets may be related to different topics, including but not limited to, operational processes and features, performance, utilization, specification, and other information that may be associated with resources, products, and services of the organization(s). The data intelligence repository's comprehensive nature may allow for a holistic view of, for example, the resources, products, and/or services.

The datasets available in the data intelligence repository may be queried or parsed to identify one or more datasets relevant to the retrieval parameter. The identification may involve, in one example, deriving at least one of semantic and contextual inferences between the retrieval parameter and the available datasets. For example, the datasets available in the data intelligence repository may be analyzed to locate or identify datasets that may be, or may comprise data, semantically or contextually relevant to the received retrieval parameter. For instance, datasets indicating resource utilization or performance figures matching the time frame specified in the retrieval parameter, and datasets indicating regional resource utilization data may be identified. Such one or more relevant datasets may be referred to as the set of relevant data.

Further, an adaptive data segmentation workflow may then be executed for the set of relevant data. The adaptive segmentation workflow may cause management of the distribution of the relevant data or datasets, present in the set of relevant data, amongst one or more segments based on various criteria. In one example, the distribution may be managed based on a prescribed computational data dimension threshold. The prescribed computational data dimension threshold may be, for instance, a range of horizontal size of data or objects present in the set of relevant data. In another example, the prescribed computational data dimension threshold may be a number of data points. For example, if the threshold is set to 50 data points, the identified set of relevant data may be partitioned into segments of 50 points each, ensuring that each segment may be manageable and appropriately presented in the record or from the record's perspective.

Another segmentation criterion, in one example, may be partitioning the set of relevant data by evaluating the semantic relationship between data in the set of relevant data. For example, Natural Language Processing (NLP) or a Large Language Model (LLM) may be used for evaluating semantic relationships between data in the set of relevant data. Each derived segment may comprise semantically dissimilar data from the set of relevant data. For example, a segment may contain data related to resource utilization in North America, another for resource utilization in Europe, and another for resource utilization in Asia, based on the semantic distinctiveness of these geographical regions. In one example, another segmentation criterion may be a data partitioning schema derived from historically recorded partitioning patterns. For example, if previous reports typically separated data by resource category, such schema may be applied, creating segments for different resource categories.

Further, a record generation signal may then be generated to indicate each of the one or more segments comprising data from the set of relevant data. In one example, the signal may trigger the creation of a record. In one example, the record may be a multi-dimensional data structure comprising the segments, where each dimension of the structure corresponds to one segment. In another example, the record may be a machine-readable file comprising multiple sections, where each section may be linked with a segment and may comprise the data of that segment.

In one example, rendering of a graphical user interface may be caused to display the record, representing the data-driven segments of the relevant data, to service the received query. The interface also may indicate, in one example, interactive components for each segment, to allow users to provide feedback or request modifications. For example, a user might interact with a first interactable component to indicate acceptance of the segment indicating resource utilization in North America, a second interactable component to flag potential errors in that segment, and a third interactable component to suggest modifications in data being presented in that section.

Further, in one example, in the data retrieval process, data tags stored in the data intelligence repository may be utilized. Each data tag may be linked to a dataset and indicate the characteristics of that dataset. In one example, the semantic conformity may be determined between the retrieval parameter and each of these data tags to identify the most relevant data tags, and thereby the datasets or the set of relevant data. In one example, this process may involve computing a semantic similarity score between the retrieval parameter and each data tag and then comparing this score to a threshold similarity score. For instance, the data tag “2020_NorthAmerica_resource_utilization” might have a higher semantic similarity score for our example query, while “2018_NorthAmerica_resource_inventory” might score below the threshold and be excluded.

The present subject matter provides several technical advantages for the management of data distribution. For example, by implementing an adaptive data segmentation workflow and utilizing the data intelligence repository, the process of record generation may be automated and the time and computational resources required to access, process, and organize large volumes of data may be significantly reduced. This efficiency gain is particularly notable when dealing with large volumes of data or complex document structures, as the automated process can rapidly parse and segment relevant information. The efficiency may be achieved through intelligent parsing of datasets based on semantic and contextual inferences, allowing for rapid identification of relevant information.

Further, the ability to segment data based on multiple criteria, including prescribed computational data dimension thresholds, semantic relationships, and historical partitioning patterns, offers a flexible and optimized approach to data organization. The adaptive data segmentation workflow may thus dynamically adjust the segmentation of data based on the nature and volume of the retrieved data, which may be suitable for varied or dynamic data, or suitable for generation of the record with such data. Such segmentation capabilities may enable the handling of varied or dynamic data, which may have varying sizes, types, and topics, thereby addressing the challenges associated with incorporating complex and diverse information into a single coherent record or document. Such segmentation capabilities may also ensure that each segment is manageable and appropriately presented, enhancing readability, information comprehension, and decision-making capabilities for users. Further, the capability to apply data partitioning schemas derived from historical patterns adds a layer of consistency and familiarity to the generated records, which may be particularly beneficial for organizations with established reporting structures.

The use of semantic and contextual inferences in identifying relevant datasets may also enable more accurate and context-aware data retrieval. This approach minimizes errors, the occurrence of irrelevant or mismatched information, and inconsistencies that are common in manual data selection processes, leading to the generation of higher quality and more reliable records. The capability to generate the records and render them through an interactive graphical user interface also enhances user engagement and allows for feedback and modifications, further refining the record creation process.

Further, by leveraging these advanced data retrieval, segmentation, and presentation techniques, the process of preparing comprehensive, data-driven records may be streamlined. The time and effort required to compile relevant information from vast data repositories may be significantly reduced, while also improving the accuracy and consistency of the resulting records or documents. This approach may be particularly beneficial for, for instance, organizations dealing with large volumes of data across various departments or regions, enabling them to generate insightful reports and make data-driven decisions more efficiently.

Further, the present subject matter may offer a significant technical advantage by enabling users to provide a retrieval parameter that indicates the data to be retrieved and subsequently generate a record with one or more segments. This approach may eliminate the need for users to repeatedly access, or switch between, multiple databases, tools, platforms, and applications manually. By centralizing data in the data intelligence repository and consolidating the data retrieval and record generation process, computational resource usage may be significantly reduced, network traffic may be minimized, energy consumption may be lowered, and the overall time required for record preparation may be reduced. This streamlined workflow may also lower the risk of human error associated with manual data gathering and integration from multiple sources, potentially improving the accuracy and consistency of the generated records. Furthermore, this automated process may allow for more efficient utilization of system resources, as it may reduce the number of concurrent database connections and application instances typically required in manual record preparation processes. Thus, the process not only saves time but also optimizes the utilization of computational resources.

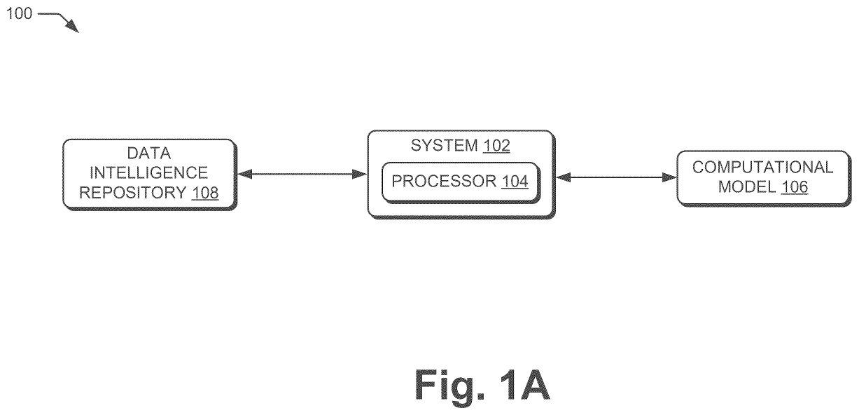

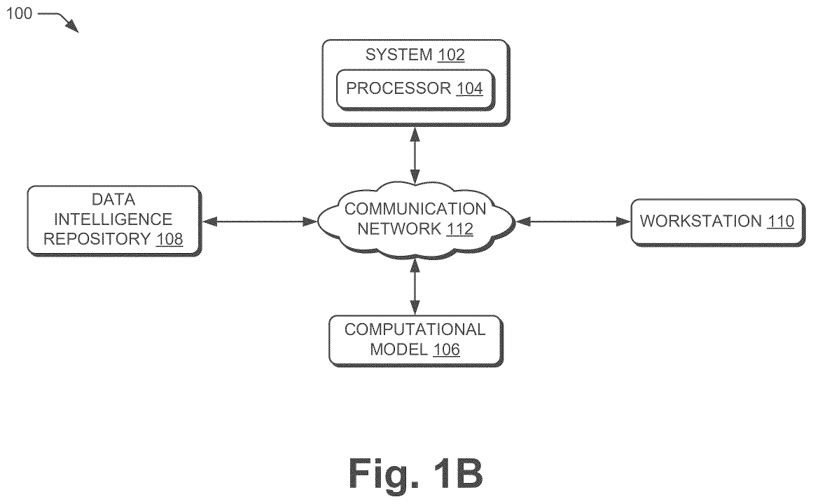

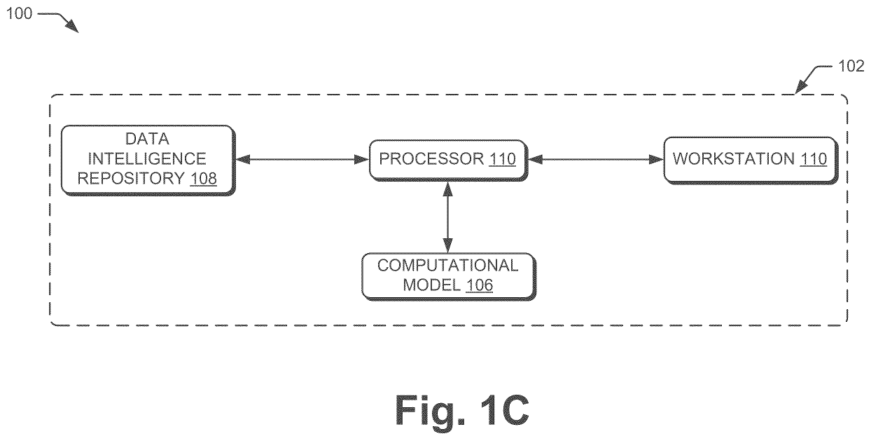

The above techniques are further described with reference to FIGS. 1A to 8. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIGS. 1A to 1C illustrate a block diagram of a computing environment 100 comprising a system 102, according to an example implementation of the present subject matter. In one example, the computing environment 100 may be a network of entities, a few of which have been illustrated in FIGS. 1A to 1C, be communicably coupled to exchange data, files, and signals. Such entities may be in the form of, for example, devices, applications, services, and platforms. The computing environment 100 may encompass various configurations and architectures to facilitate data distribution management and efficient record generation. For example, the computing environment 100 may comprise a network of interconnected devices, servers, and databases that may seamlessly communicate and exchange data therebetween.

In one example, the computing environment 100 may comprise the system 102. The system 102, in one example, may comprise a processor 104 and may be capable of exchanging data with the entities of the computing environment 100. The system 102 may also be capable of exchanging data and signals with entities, devices, or platforms that may be external to the computing environment 100. In one example, the system 102 may also be capable of managing the distribution of data. The system 102 may analyze and process the data and execute one or more workflows or operations for managing the distribution of data. Such distribution management may be, in one example, for generation of one or more files or records comprising efficiently organized or segmented data.

Further, in one example, the computing environment 100 may comprise a computational model 106 that may be communicably linked with the system 102. The computational model 106 may comprise an algorithm, a mathematical function, or a computational framework designed to process input data and generate outputs, predictions, or decisions based on that data. For example, the computational model 106 may involve an algorithm, a mathematical function, or a computational framework that enables analysis and derivation of interpretations from the data. The computational model 106 can vary in complexity, ranging from simple rule-based systems to advanced machine learning models that learn from data over time.

Examples of computational model 106 may include, but are not limited to, Natural Language Processing (NLP) models. The computational model 106 may employ a variety of techniques, for example, rule-based techniques or systems that use linguistic rules, machine learning models like decision trees or support vector machines, or more advanced models like Large Language Models (LLMs), which utilize deep learning techniques to understand data and generate outputs. These models can be applied in a wide range of tasks linked with the computing environment 100, comprising data analysis, data classification, and data distribution management.

In one example, the computational model 106 may be a pre-trained NLP model or an LLM capable of analyzing data and deriving semantic and contextual similarities. In another example, computational model 106 may be specifically trained or configured through various techniques and approaches to analyze data and derive semantic and contextual similarity between data. Such training processes may involve several steps and methodologies to enable the model to effectively understand and compare the meaning and context of different pieces of data.

In one example approach, the computational model 106 may be trained using a large corpus of text data to learn semantic representations. This process, often referred to as word embedding, may involve techniques such as Word2Vec, GloVe, or FastText. These methods may allow the computational model 106 to learn vector representations of words in a high-dimensional space, where words with similar meanings are positioned closer together. The computational model 106 may then use these learned representations to compute semantic similarity between words or phrases by measuring the distance between their corresponding vectors.

For advanced semantic understanding, the computational model 106 may be trained using transformer-based architectures like BERT (Bidirectional Encoder Representations from Transformers) or its variants. These models may be pre-trained on vast amounts of text data using unsupervised learning techniques such as masked language modelling and next sentence prediction. This pre-training may allow the computational model 106 to capture complex semantic relationships and contextual nuances.

To further refine the computational model's ability to derive semantic and contextual similarity, in one example, the computational model 106 may also undergo fine-tuning on task-specific datasets. Such processes may involve training the computational model 106 on pairs of sentences or text snippets labelled with similarity scores. The computational model 106 may learn to predict or determine these similarity scores, adjusting its parameters to better capture the nuances of semantic and contextual similarity in the specific domain or task.

Further, to enhance the computational model's understanding of context, the computational model 106 may be trained on tasks that require considering the surrounding text or document structure. For instance, the computational model 106 may be trained on document classification tasks, where it learns to understand how individual words and phrases contribute to the overall meaning and context of a document. Thus, different techniques or approaches may be implemented for training the computational model 106 to make it capable of analyzing data and deriving semantic and contextual inferences between data.

The training process may also incorporate techniques to handle different types of data beyond text, such as images or structured data. For instance, the computational model 106 may be trained on multimodal datasets that combine text with other forms of data, allowing it to derive semantic and contextual similarities across different data modalities. Throughout the training process, various regularization techniques may be employed to prevent overfitting and improve the computational model's generalization capabilities. These may include methods such as dropout, weight decay, or early stopping. Further, the computational model's performance in deriving semantic and contextual similarities may be evaluated using benchmark datasets and metrics specific to semantic similarity tasks. This evaluation process may guide further refinements and iterations in the training approach to improve the computational model's accuracy and robustness.

The computational model 106, in one example, may be implemented or deployed on the processor 104 as a set of algorithms, computational frameworks, functions or mathematical equations. In another example, the computational model 106 may be implemented on a hardware device or any platform that may be accessible to the system 102 or at least the processor 104. For example, the computational model 106 may be implemented or hosted by a cloud-based platform or and may be accessible to the system 102, or at least the processor 104, for the exchange and processing of data. Further, the computational model 106 may be used for various purposes within the computing environment 100. For example, the computational model 106 may be used for data analysis and deriving semantics and contextual inferences between different pieces of data, as will be discussed.

Further, in one example, the computing environment 100 may comprise a data intelligence repository 108. In one example, the data intelligence repository 108 may be linked with an organization and may store valuable information across multiple departments and functions. For example, the data intelligence repository 108 may store a wide range of data encompassing various aspects of an organization's operations, resources, products, services, and historical performance or operations. Such data may be a comprehensive resource and may be usable, for example, for generating various records, reports, or documents essential for the organization. Thus, the data intelligence repository 108 may collect and store a vast range of data linked with the organization that can be leveraged to create these records as needed.

For example, the data intelligence repository 108 may store detailed product data, which can be used to generate quality control reports, regulatory filings, or product specifications. The data may be, for example, data on product testing, performance characteristics, test results, defect rates, and compliance with industry standards. Similarly, the data intelligence repository 108 may hold regulatory compliance data, including clinical trial outcomes and safety reports, which may be usable for generating FDA reports or other necessary compliance records.

In one example, the data intelligence repository 108 may also store financial data, such as revenue figures, expenses, asset information, and cost breakdowns. While the data itself is stored in the data intelligence repository 108, it can be used to create records, for example, balance sheets, income statements, and cash flow reports. Similarly, sales data such as customer demographics, sales volumes, and revenue trends may be stored in the data intelligence repository 108 and may be usable for generating sales records or market analysis records. The data housed in the data intelligence repository 108 may enable the creation of such records by providing detailed insights into both historical and current performance.

In one example, the data intelligence repository 108 may also house extensive human resources data, including information about employee performance, training certifications, and workforce allocation. Such data may be leveraged to generate internal reports on employee performance, training needs, or resource utilization. Additionally, the data intelligence repository 108 may store inventory data, tracking product stock levels, supplier information, and logistics metrics. This raw inventory data may be usable for creating operational reports, such as inventory management reports or supply chain performance analyses.

The data intelligence repository 108 may also store, in one example, market intelligence data. This may include information on industry trends, competitive analysis, and customer feedback. Such data may be usable for generating records related to, for example, customer satisfaction and competitive analysis reports. The data intelligence repository 108 may also store both historical data and predictive data, which can be crucial for long-term strategic planning. Historical data, such as previous sales trends or past compliance records, can be used to create records that analyze past performance and forecast future trends. Predictive data, such as demand forecasts or risk assessments, can be used to generate records on anticipated market conditions, inventory needs, or potential business risks.

In one example, the data intelligence repository 108 may also store resource utilization data, including performance metrics, energy consumption, or computing resource usage. This data may be usable for generating records indicating, for example, server load, network bandwidth utilization, or energy efficiency. For instance, an Information Technology (IT) department may create a record or report that shows peak usage times for cloud resources or identify underutilized hardware, which can help optimize infrastructure planning and cost-saving strategies.

The data intelligence repository 108 could also house production data such as machine downtime, operational throughput, and labour allocation in a manufacturing environment. This data could be used to generate operational efficiency records, highlighting production bottlenecks, areas where output can be increased, or shifts in productivity over time. These insights would allow for better scheduling, resource allocation, and workforce optimization.

The data intelligence repository 108 could store data on network traffic, hardware health, software performance, and system logs. From such data, IT teams could generate operational health reports, which might include metrics like uptime, error rates, patch deployment statuses, and system vulnerabilities. These reports could be critical for identifying potential IT infrastructure weaknesses or for planning future capacity expansions.

Data related to supplier performance, lead times, order accuracy, and logistics tracking could be stored in the data intelligence repository 108. These datasets may be used to generate supply chain performance reports that show trends in delays, cost overruns, or supplier performance. Further, if the organization manages physical assets like machinery, vehicles, or real estate, the data intelligence repository 108 may store asset lifecycle data, such as maintenance schedules, repair history, and depreciation rates. The data intelligence repository 108 could house data on resource consumption, such as energy, water, and raw material usage in production.

Similarly, the data intelligence repository 108 may collect and store a vast range of data from various domains linked with the organization that can be leveraged to create these records as needed. The data intelligence repository 108 may thus be, in one example, a comprehensive backend database, or a collection of such databases, of an organization. While some examples of such data have been discussed above, there can be multiple additional examples that may relate to data linked with multiple departments, functions, operations, resources, products, services, and historical performance of the organization. Further, in one example, it may also be possible that the data intelligence repository 108 may collect and store such data about multiple organizations.

Thus, the data intelligence repository 108 may serve as a centralized and comprehensive storage comprising a vast range of data. The data intelligence repository 108 may house a diverse array of data types, spanning across multiple facets of the organization's business and activities, and may be instrumental in supporting informed decision-making, compliance, and operational efficiency. Further, by organizing such vast data effectively, the data intelligence repository 108 may allow the creation of the necessary records to meet internal and external needs. Such data may thus be a comprehensive resource usable for generating various records, reports, or documents essential for the organization's operations, compliance, decision-making, and strategic planning.

Such an approach may ensure that all, or at least the majority of, organizational data is collectively stored, making it easy to access and utilize for a variety of purposes. Such a solution may enhance operational efficiency. Such consolidating of necessary or all organizational data may reduce the need for multiple disparate systems or manual data gathering. This streamlined access to data enables quick searching and finding of the required information without delays, ultimately speeding up record generation or decision-making processes.

In some aspects, the data intelligence repository 108 may feature robust data governance and security measures. This could involve implementing, for example, role-based access controls and encryption protocols to ensure data integrity, security, and compliance with various data protection regulations. Such measures may be particularly important for sensitive information like financial data, personal employee information, or proprietary business intelligence.

The data intelligence repository 108 may also, in certain implementations, support integration with various external data sources. This could include, for example, Application Programming Interfaces (APIs) for connecting to third-party databases or scraping tools for gathering publicly available information, such as on web pages. Such connectivity may enhance the comprehensiveness and timeliness of the data stored in the data intelligence repository 108.

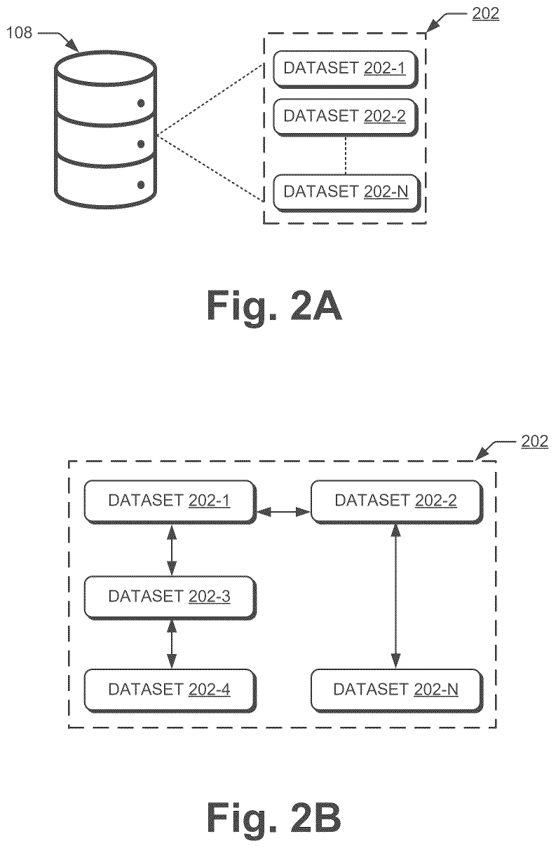

Further, the data intelligence repository 108 may store both structured and unstructured data, allowing for flexibility in data collection and storage methods. In one example, the data intelligence repository 108 may store data in the form of datasets. For example, the data intelligence repository 108 may comprise a plurality of datasets 202, as illustrated in FIG. 2A. FIG. 2A illustrates a block diagram of the data intelligence repository 108 comprising the plurality of datasets 202, according to one example implementation of the present subject matter. The plurality of datasets 202 may comprise a first dataset 202-1, a second dataset 202-2, . . . , and an Nth dataset 202-N. The first dataset 202-1, the second dataset 202-2, . . . , and the Nth dataset 202-N may hereinafter collectively be referred to as the datasets 202 and individually be referred to as the dataset 202.

These datasets 202 may serve as organized collections of related information within the data intelligence repository 108. In some aspects, the datasets 202 may be structured in various formats, such as tables, arrays, or hierarchical structures, depending on the nature of the data and the specific requirements of the system. In one example, each dataset 202 may be a collection or cluster of data having at least one common characteristic. These characteristics may encompass a wide range of attributes, including but not limited to topic, theme, type, and format of data. The common characteristic may serve as an organizing principle for the datasets 202, allowing related information to be grouped and accessed efficiently. For example, the datasets 202 may be organized based on specific operational or analytical needs. For instance, certain datasets within the plurality of datasets 202 may be dedicated to storing performance metrics for various computational or operational resources within an organization. In this scenario, each dataset 202 may be associated with a particular resource, containing detailed information about its performance metrics. These metrics may include parameters such as processing speed, memory usage, network latency, or any other relevant performance indicators specific to that resource.

In one example, the datasets 202 may also be structured to accommodate different topics or themes. For example, the first dataset 202-1 may be designed to store comprehensive performance metrics across multiple resources. This dataset may include, for example, time-series data tracking various performance indicators over specified periods, allowing for trend analysis and performance optimization. In contrast, the second dataset 202-2 may focus on a different theme, such as the geographical distribution of these resources. This dataset may contain, for example, location data, regional performance statistics, or other geographically relevant information. Such a dataset may be particularly useful for organizations with distributed resources or those seeking to optimize resource allocation based on geographical factors.

Similarly, the data intelligence repository 108 may comprise multiple datasets 202, where each dataset 202 may comprise a set of data having at least one common characteristic. The flexibility of the data intelligence repository 108 allows for the creation and management of multiple datasets 202, each tailored to specific data characteristics or analytical requirements. This structure enables efficient data organization, retrieval, and analysis, as each dataset 202 comprises a set of data unified by at least one common characteristic.

Further, in some cases, the datasets 202 within the data intelligence repository 108 may be interconnected, as illustrated in FIG. 2B. FIG. 2B illustrates a block diagram indicating probable interconnections between datasets 202, according to one example implementation of the present subject matter. Such interconnections may allow complex relationships and dependencies to be established between different sets of data. This interconnectedness may enable more comprehensive analysis and insights to be derived from the stored information. For instance, the data intelligence repository 108 may implement a relational structure between datasets 202, where data from one dataset can reference or link to data in another dataset. This relational approach may allow for the creation of multi-dimensional data models that span across multiple datasets.

In one example, the first dataset 202-1 containing performance metrics of multiple resources may be linked to the second dataset 202-2 which comprises data indicating the geographical distribution of the resources. This interconnection may enable analyses that correlate performance metrics with geographical locations, potentially revealing patterns or insights that may not be apparent when examining each dataset in isolation. In some implementations, the interconnectedness may extend to temporal relationships between datasets. For example, historical performance data in one dataset may be linked to current operational data in another, enabling trend analysis and predictive modelling across different time periods.

The data intelligence repository 108 may also implement metadata-driven connections between datasets 202. In this approach, common metadata attributes across different datasets 202 may be used to establish implicit relationships, facilitating dynamic data discovery and integration. Furthermore, the interconnected nature of the datasets 202 may support cascading updates, where changes in one dataset automatically propagate to related datasets, ensuring data consistency across the repository. This feature may be particularly useful in maintaining data integrity in complex, interdependent data structures.

Such datasets 202 may be created through various methods, including manual compilation or by utilizing the computational model 106, such as NLP models or LLMs. In some aspects, manual creation of datasets 202 may involve human experts curating and organizing data based on predefined criteria or specific requirements, such as the characteristic based clustering of data. Alternatively, NLP models may be employed to automatically process and categorize large volumes of unstructured data, enabling the creation of structured datasets 202 based on linguistic patterns, semantic relationships, or other relevant features.

Further, in one example, each dataset 202 within the data intelligence repository 108 may have a data tag associated with it. This data tag may serve to indicate the characteristics or attributes of the data contained within the dataset 202. The data tag may act as a descriptive identifier, providing a quick and efficient means of categorizing and/or identifying the datasets 202. In some cases, the data tag can be a given name assigned to the dataset 202, providing a quick reference to its contents or purpose. For instance, the data tag may be a simple text string or name assigned to the dataset. For example, the first dataset 202-1 comprising performance metrics of multiple resources may have a data tag such as “ResourcePerformanceMetrics”, while the second dataset 202-2 containing geographical distribution data may be tagged as “ResourceGeographicalDistribution”.

In other cases, the data tag may be more complex, taking the form of a structured metadata associated with the dataset. For example, the data tag may be represented as a table associated with the dataset, potentially containing metadata or summary information about the dataset's contents, structure, or origin. For example, the structured data may contain multiple fields describing various aspects of the dataset, such as dataset name which may be an identifier for the dataset; date when the dataset was first created or imported into the data intelligence repository 108; type of data contained (for example, numerical, categorical, time-series); structure or format of the data (for example, CSV, JSON, XML); origin or source of the data, Information about who can view or modify the dataset; references to other datasets that may be linked or relevant; and brief summary of the dataset's contents and purpose. Thus, each dataset may have a data tag or label associated therewith, which describes or indicates at least one characteristic about the set of data contained within the dataset.

The use of data tags may facilitate efficient organization, retrieval, and management of datasets 202 within the data intelligence repository 108. These data tags may facilitate quick search and retrieval of specific datasets, allowing efficient locating and accessing of the necessary or required information. The use of data tags may enhance data discovery and exploration in such a vast or comprehensive data intelligence repository 108. By providing descriptive information about each dataset, data tags can assist in quickly understanding the contents and relevance of different data collections without needing to examine the data in detail. In some aspects, data tags may also be used to establish relationships between different datasets 202. This capability may allow for the creation of more complex data structures and enable more comprehensive analyses across multiple datasets 202, potentially uncovering insights that may not be apparent when examining datasets in isolation.

Additionally, the data tags may enable automated data processing based on dataset characteristics, streamlining various analytical and operational tasks within the repository. Data tags may also support data governance and compliance efforts. By providing clear identifiers and metadata for each dataset, organizations can more easily track and manage their data assets in accordance with regulatory requirements and internal policies. Furthermore, these tags may assist in data lineage tracking and version control, helping users understand the origin and evolution of datasets over time.

Further, the data tags associated with each dataset 202 in the data intelligence repository 108 may be assigned through various methods, including manual assignment and automated processes using the computational model 106. In manual assignment, human experts or data administrators may review the contents and characteristics of each dataset 202 and assign appropriate data tags based on their knowledge and understanding of the data. For example, a data administrator might manually assign the tag “ResourcePerformanceMetrics” to the first dataset 202-1 containing performance metrics of multiple resources, and “ResourceGeographicalDistribution” to the second dataset 202-2 comprising data on the geographical distribution of resources.

Alternatively, the computational model 106, such as a NLP model, may be employed to automatically analyze datasets 202 and tag these datasets 202. The computational model 106 may be trained to recognize patterns, themes, and characteristics within the data, and assign appropriate data tags based on the analysis. For instance, an NLP model might analyze the content of a dataset and automatically identify that it contains performance metrics, assigning relevant tags such as “PerformanceData” or “ResourceMetrics” without human intervention. In some implementations, a hybrid approach may be used, where NLP models perform initial automated data tagging, followed by manual review and refinement. These NLP-based tagging systems may be continuously trained and improved using feedback from human experts and users of the data intelligence repository 108, enhancing their accuracy and effectiveness over time.

Thus, the data intelligence repository 108 may be a collection of data or datasets 202, where each dataset may have linked therewith a data tag indicating at least one characteristic about the dataset. In one example, such datasets 202 may contain information linked with an organization. In another example, such datasets 202 may contain information linked with multiple organizations. In such case, each dataset may be linked with an organization and may act as a secure and isolated data container comprising information linked with that organization. Thus, in this case, the data intelligence repository 108 may be a collection of datasets 202, where each dataset may be linked with an organization. Further, in this example, each dataset may include one or more sub-datasets, where each sub-dataset may comprise a set of data having at least one common characteristic. As a comprehensive backend database, the data intelligence repository 108 may provide a holistic view of operations of one or more organizations and their products and services by consolidating diverse data types into a single, accessible system. This consolidation may allow for cross-referencing and integration of information across different aspects of one or more organizations. The repository's comprehensive nature may enable multi-dimensional analysis. For instance, financial data could be analyzed in conjunction with operational metrics to assess the cost-effectiveness of various processes. Product specifications might be evaluated alongside customer feedback data to inform future product development decisions.

Further, the data intelligence repository 108 may be implemented by one or more physical storage devices, virtual storage instances, or a combination thereof. In one example, the data intelligence repository 108 may include one or more data storage units. In another example, the data intelligence repository 108 may include only a single data storage unit. In one example, the data intelligence repository 108 may implement distributed data storage techniques. For example, the data or content may be stored in a distributed manner across the one or more data storage units. Also, in one example, the data or content can also be replicated on the one or more data storage units. Distribution and data replication may enhance fault tolerance against loss of data, for example, due to failure or loss of connection with any of the data storage units.

Further, in one example, the one or more data storage units may be located at different locations and may be communicably coupled with each other. The one or more data storage units, in one example, may also have different properties. For example, some of the data storage units may have high-speed read/write capabilities as compared to the other data storage units of the data intelligence repository 108. The data intelligence repository 108 may dynamically enable read and write operations at varying speeds based on different conditions, for example, importance level associated with queries or requests to read and write data from/to the data storage units.

In one example, the computing environment 100 may further comprise a workstation 110. In some examples, the workstation 110 may be a software-based application or tool. Examples of such tools and software may include, but are not limited to, data analysis tools, websites or webpages, cloud-hosted platforms, analytical tools, and statistical tools. In some instances, the workstation 110 may be a hardware-based device. Examples of such workstation 110 may include, but are not limited to, a computing system or a desktop, a mobile phone, and a laptop. Such a workstation 110, in one example, may execute software-based applications or tools that may be accessed by a user. In one example, the user may be associated with an organization. Examples of such users or individuals may include, but are not limited to, department leads, review project managers, approvers, business admins, developers, quality assurance agent(s), support staff, an engineer, or any operator or worker associated with the organization or computing environment 100.

Further, in one example, the workstation 110 may comprise of a display device and an input mechanism. The input mechanism may be, for example, a keyboard, mouse, or even a touch input received on the display device of the workstation 110. In one example, the display device may be capable of rendering graphical user interface(s). The graphical user interface may be, for example, an interactive interface with which the user may be able to interact and view different information. For example, the user may be able to view, interact, modify, and customize the information being rendered via the display device and the input mechanism associated with the workstation 110. In one example, the graphical user interface may be a dashboard that may be rendered on the display device.

Further, the system 102, the computational model 106, the data intelligence repository 108, and the workstation 110 may be communicably coupled with each other to exchange data, records, and signals. In one example, the coupling may be direct, either wirelessly or through one or more wires. In another example, the system 102, the computational model 106, the data intelligence repository 108, and the workstation 110 may be communicably coupled via a communication network 112 to exchange data, records, and/or signals. The computing environment 100 may thus be a network of such entities that may be communicably coupled with each other, for example, over the communication network 112 to exchange data, records, and/or signals. Examples of the communication network 112 may include, but are not limited to LAN, WAN, the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 112 may include various network entities, such as transceivers, gateways, and routers. In an example, the communication network 112 may include any communication network that uses any of the commonly used protocols, for example, Hypertext Transfer Protocol (HTTP), and Transmission Control Protocol/Internet Protocol (TCP/IP).

Thus, the computing environment 100 illustrates an example of an environment having different entities or components that may be communicably coupled with each other. Further, FIGS. 1A and 1B illustrate that the system 102 may be communicably coupled with the computational model 106, the data intelligence repository 108, and the workstation 110. However, other implementations may also be possible. For example, the system 102 may comprise the processor 104, the computational model 106, the data intelligence repository 108, and the workstation 110, as illustrated in FIG. 1C. Further, in one implementation, the computing environment 100 may be a cloud-based infrastructure, where the system 102, data intelligence repository 108, and computational model 106 are hosted on remote servers accessible via the internet. This setup allows for scalability and flexibility, enabling organizations to access and process large volumes of data without the need for extensive on-premises hardware. Alternatively, the computing environment 100 could be an enterprise-level network within an organization, comprising multiple interconnected local servers, workstations, and specialized hardware for data processing and storage. This configuration may be suitable for organizations that prefer to keep their data and processes within their own infrastructure for security or compliance reasons. Similarly, different architectures may also be possible, though not illustrated.

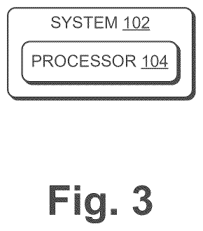

FIG. 3 illustrates a block diagram of the system 102, according to one example implementation of the present subject matter. FIG. 3 will be discussed in conjunction with FIGS. 1A to 2B and the description of FIGS. 1A to 2B may be incorporated for reference and for the sake of brevity.

In one example, the system 102 may be capable of analyzing and processing the data and executing one or more workflows or operations for managing distribution of data. Such distribution management may be, in one example, for generation of one or more records comprising efficiently organized or segmented data. Further, the system 102 may comprise the processor 104.

In one example operation, the processor 104 may receive a query signal indicating an input descriptor. The input descriptor may be indicative of a retrieval parameter for querying the data intelligence repository 108 to service the query signal. The processor 104 may then parse datasets 202 available in the data intelligence repository 108 to identify a set of relevant data based on the retrieval parameter. The set of relevant data may be identified, in one example, by deriving at least one of semantic inference and contextual inference between the retrieval parameter and the datasets 202 available in the data intelligence repository 108. The set of relevant data may comprise one or more datasets from amongst the datasets 202. In another example, the set of relevant data may comprise data derived from the datasets 202, having at least one of semantic inference and contextual inference.

For the set of relevant data, the processor 104 may execute an adaptive data segmentation workflow. The adaptive segmentation workflow may be executed to manage distribution of the set of relevant data amongst one or more segments. The distribution may be managed or caused based on at least one of a prescribed computational data dimension threshold, a semantic relationship between data in the set of relevant data, and a data partitioning schema derived based on partitioning of data indicated by a set of records historically recorded.

In one example, the prescribed computational data dimension threshold may be a range of size of data or objects present in the set of relevant data. In another example, the prescribed computational data dimension threshold may be a number of data points. For example, if the threshold is set to 500 text characters, the processor 104 may partition the identified set of relevant data into segments such that each segment may comprise 500 text characters. Thus, each of the one or more segments may be derived by dividing the set of relevant data based on the prescribed computational data dimension threshold.

In one example, the distribution of the set of relevant data may be managed amongst the one or more segments based on the semantic relationship between data in the set of relevant data. Each of the one or more segments may be derived based on semantic distinctiveness between data in the set of relevant data. Each derived segment may comprise semantically dissimilar data from the set of relevant data. For example, data may be distributed across the one or more segments based on the underlying semantics or inherent meaning within the data. Semantic relationships between different elements in the data may be analyzed to group them into distinct segments. Each segment may then represent a collection of data that shares a common semantic theme.

In one example, the distribution of the set of relevant data may be managed amongst the one or more segments based on the data partitioning schema derived based on partitioning of data indicated by the set of records historically recorded. Each of the one or more segments may be derived by distributing the data, in the set of relevant data, based on the data partitioning schema. For example, if the set of records historically recorded typically separated data by resource category, such schema may be applied, creating segments for different resource categories. Further, the processor 104 may generate a record generation signal to indicate each of the one or more segments comprising data from the set of relevant data.

Thus, data corresponding to the retrieval parameter may be indicated in an organized and optimized manner, for example, for generation of one or more records with improved space utilization and pagination. By leveraging semantic and contextual inferences, the system intelligently parses and segments data based on relevant criteria, including computational thresholds, semantic relationships, and historical partitioning patterns. This dynamic segmentation ensures efficient handling of diverse and complex data, resulting in more manageable, coherent records that enhance readability and decision-making. Additionally, through the centralization of data in the data intelligence repository 108, relevant information may be retrieved without repeatedly accessing multiple sources or platforms, leading to reduced network traffic and lower energy consumption. This streamlined workflow optimizes system resources, reduces human error, and significantly accelerates the generation of data-driven records, making it particularly beneficial for organizations managing large volumes of data.

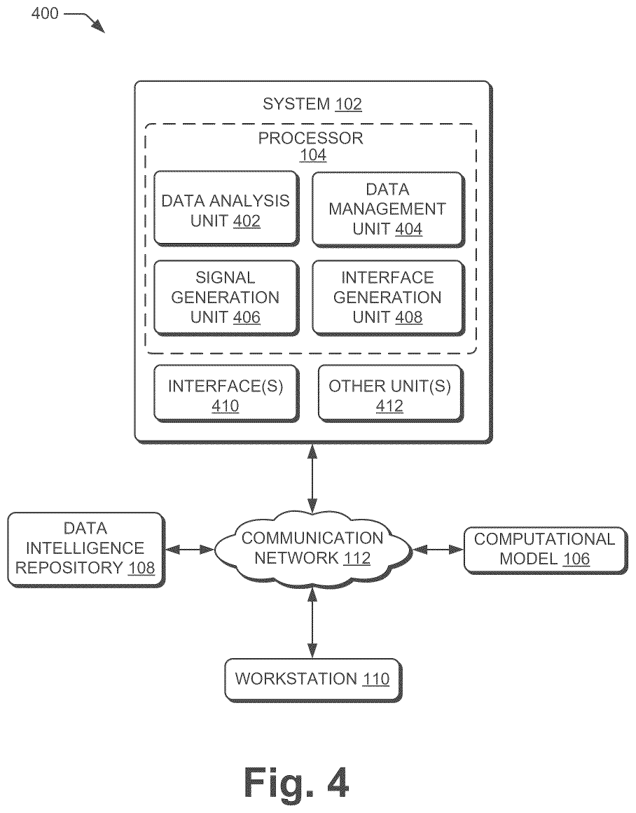

FIG. 4 illustrates a block diagram of a computing environment 400 comprising the system 102, according to another example implementation of the present subject matter. FIG. 4 will be discussed in conjunction with FIGS. 1A to 3 for the sake of brevity and the description of FIGS. 1A to 3 may be incorporated herein for reference.

In one example, the computing environment 400 may be similar to the computing environment 100, as discussed in reference to FIGS. 1A to 1C. The computing environment 400 may comprise the system 102 communicably coupled with at least one of the computational model 106, the data intelligence repository 108, and the workstation 110.

In one example, the computing environment 400 may comprise the system 102 capable of exchanging data with the entities of the computing environment 400. The system 102 may also be capable of exchanging data and signals with entities, devices, or platforms that may be external to the computing environment 100. Further, the system 102 may be capable of analyzing and processing the data and executing one or more workflows or operations for managing the distribution of data. Such distribution management may be, in one example, for generation of one or more files or records comprising efficiently organized or segmented data. In one example, the system 102 may also be capable of causing rendering of one or more graphical user interfaces to indicate the organized or segmented data and receive feedback for the segmented data.

The system 102 may be implemented in various ways. In one example, the system 102 may be implemented in the computing environment 100 as a set of one or more hardware devices or modules for analyzing and managing distribution of data. For example, the system 102 may be implemented as a set of one or more hardware devices, comprising at least the processor 104. The processor 104 may be implemented as a dedicated processor, a shared processor, or a plurality of individual processors, some of which may be shared. Examples of the processor 104 may include, but are not limited to, microprocessors, microcomputers, microcontrollers, digital signal processors, Central Processing Units (CPUs), state machines, Artificial Intelligence (AI) based processors, Machine Learning-based processors, deep learning-based processors, System-on-Chip (SOC), Graphics Processing Units (GPUs), Tensor Processing Units (TPUs), Field-Programmable Gate Arrays (FPGAs), Application-Specific Integrated Circuits (ASICs), processing circuitries including one or more modules or engines, and any other devices that manipulate signals and data based on computer-readable instructions.

In one example, the processor 104 may include one or more sub-processing units or engines. For example, the processor 104 may comprise a data analysis unit 402, a data management unit 404, a signal generation unit 406, and an interface generation unit 408. The units may be implemented as a combination of hardware and programming, for example, programmable instructions to implement a variety of functionalities of the units. In examples described herein, such combinations of hardware and programming may be implemented in several different ways. For example, the programming for the units or engines may be executable instructions. Such instructions in turn may be stored on a non-transitory machine-readable storage medium which may be coupled with the system 102 either directly or indirectly (for example, through networked means). In an example, it may also be possible that each of the units or engines includes a processing resource, for instance, a single processor or a combination of multiple processors, to execute such instructions. In one example, such instructions may be stored in a memory of other unit(s) 412 of the system 102. In other examples, the units or engines may be implemented as electronic circuitry.

Further, the system 102 may comprise, in one example, interface(s) 410. The interface(s) 410 may include a variety of software and hardware interfaces that allow interaction of the system 102 with other communication and computing devices, such as network entities, web servers, external repositories, and peripheral devices, such as input/output (I/O) devices. For example, the interface(s) 410 may communicably couple the system 102 with at least one of the computational model 106, the data intelligence repository 108, and the workstation 110. The interface(s) 410 may also enable the coupling of internal components of the system 102 with each other.

The system 102 may further comprise, in one example, the other unit(s) 412. The other unit(s) 412 may include, in one example, a power supply unit, a communication unit, and the memory. The power supply unit may, for example, manage distribution or supply of electrical current within the system 102 for functioning of the system 102. Further, the communication unit may be, in one example, a wireless communication unit. Examples of the communication unit may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication unit may also include one or more antennas to enable wireless transmission and reception of data and signals. The communication unit may allow the system 102 to be communicably coupled with at least one of the computational model 106, the data intelligence repository 108, and the workstation 110. Also, the communication unit may allow the system 102 to transmit and receive data, files, and/or signals.

Further, the memory may include any computer-readable medium known in the art including, for example, volatile memory, such as Static Random-Access Memory (SRAM) and Dynamic Random-Access Memory (DRAM), and/or non-volatile memory, such as Read Only Memory (ROM), Erasable Programmable ROMs (EPROMs), flash memories, hard disks, optical disks, and magnetic tapes. In one example, the memory may store the data received, processed, or generated by the system 102 and/or the processor 104.

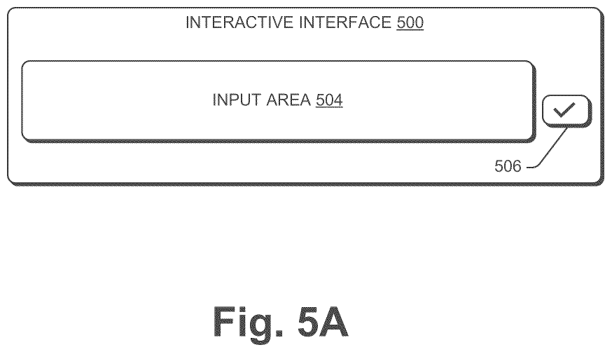

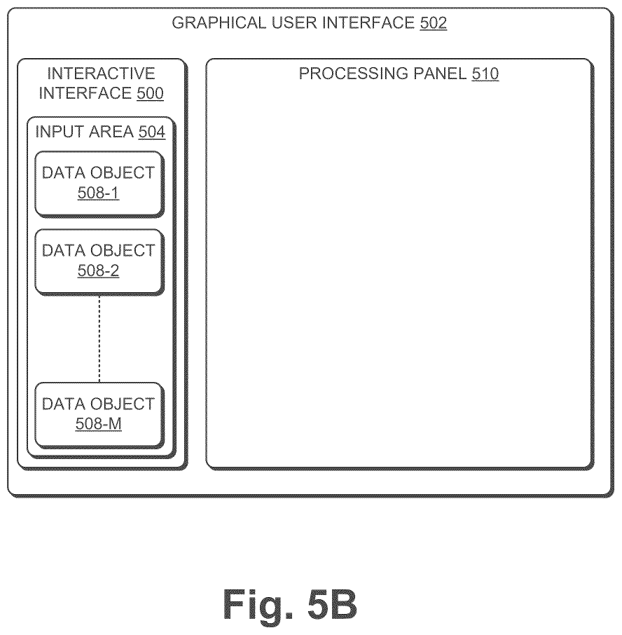

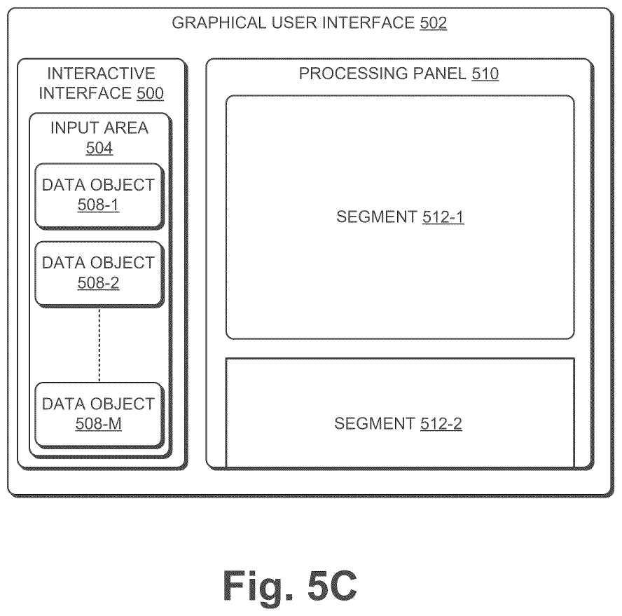

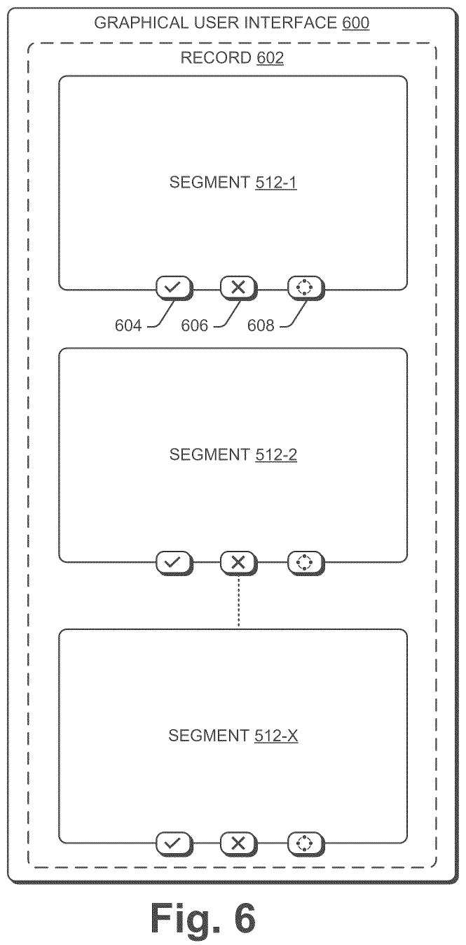

In one example operation, the processor 104, or the data analysis unit 402, may receive a query signal indicating an input descriptor. The input descriptor may be indicative of a retrieval parameter for querying the data intelligence repository 108 to service or fulfil the query signal. In one example, the query signal may be generated by an interactive interface in response to receiving the input descriptor indicating the retrieval parameter. In one example, the processor 104, or the interface generation unit 408 may cause rendering of the interactive interface, such as the interactive interface 500 illustrated in FIGS. 5A to 5C. FIG. 5A illustrates a block diagram of the interactive interface 500, according to one example implementation of the present subject matter. FIGS. 5B and 5C illustrate a block diagram of a graphical user interface 502 comprising the interactive interface 500, according to one example implementation of the present subject matter.

In one example, the interactive interface 500 may be a graphical user interface, as illustrated in FIG. 5A, which may be rendered by the processor 104 on the display device of the workstation 110. In another example, the interactive interface 500 may appear as a component of the graphical user interface 502, as illustrated in FIGS. 5B and 5C, similarly rendered on the workstation 110. In one example, the interactive interface 500 or the encompassing graphical user interface 502 may be locally hosted on the workstation 110. In this scenario, the processor 104 may execute a locally installed software application that renders the interface on the workstation 110, potentially as an integral part of the application. In another implementation, the processor 104 may render the interactive interface 500 or the graphical user interface 502 as part of a cloud-based platform, accessible to the workstation 110 via the internet through the communication network 112. Various other approaches for rendering the interactive interface 500 may also be employed.

Further, the interactive interface 500 may be capable of receiving the input descriptor that specifies or indicates the retrieval parameter. In one example, the interactive interface 500 may comprise an input area 504 for receiving an input, referred to as the input descriptor, from the user. In one example, the input descriptor may be in the form of a textual information or query. For instance, the input area 504 might receive an input descriptor such as “batches data of Routers”. The input area 504 may be configured to accommodate various query formats, and the input descriptor may comprise a set or group of such queries.

In one example, the interactive interface 500 may also include a submit button 506 that may enable the user to submit the query or the input descriptor. Further, submission of the input descriptor may generate the query signal and may be communicated from the interactive interface 500 to the processor 104. That is, the query signal may be generated by the interactive interface 500 in response to receiving the input descriptor, and the query signal may be received by the processor 104 from the interactive interface 500. The query signal may be, for example, a signal, message, response, or set of instructions received by the processor 104 from the interactive interface 500 that indicates the submission of the input descriptor or query.

In one example, the input descriptor may be a data object that may be submitted by the user. For example, the interactive interface 500 may render a plurality of data objects 508-1, 508-2, . . . , and 508-M, where M is a natural number. The plurality of data objects 508-1, 508-2, . . . , and 508-M may hereinafter collectively be referred to as data objects 508. The software application or the cloud-based platform hosting the interface 500 or graphical user interface 502 may present these data objects 508. In some instances, these data objects 508 may be predefined and indicate specific characteristics of the data to be retrieved. Examples of such predefined data objects 508 may include, but are not limited to, graphs, logos, template textual queries, and images. For instance, a “graph” data object might signify that a graph or data for creating a graph needs to be retrieved from the data intelligence repository 108. Additional details may be incorporated to specify required information, such as a data object 508 representing a “graph of sales”. Template textual queries may be predefined by users, such as organizational experts, based on user preferences or organizational requirements, and displayed in the interactive interface 500. One such template query might be “batches data”.

Such data objects 508 may be, in one example, interactive. For example, the user, through the workstation 110, may be able to select, drag, or drop one or more data objects 508 to a processing panel 510 of the graphical user interface 502. The processing panel 510 may be capable of receiving the one or more data objects 508. Selection or dropping of the data objects 508 may indicate submission of the input descriptor and may generate the query signal. The processor 104 may receive such a query signal.

Since the input descriptor provides information about the data which is to be retrieved, it may effectively indicate the retrieval parameter. That is, the input descriptor may serve as a key indicator for the retrieval parameter, effectively guiding the data retrieval process. In some aspects, the input descriptor may encapsulate specific details or characteristics of the desired information that is to be retrieved. For example, the input descriptor “batches data of Routers” indicates that information about batches of routers is to be retrieved. When an input descriptor such as “batches data of Routers” is provided, it may be interpreted to contain multiple components that may influence the retrieval process. The term “batches” may suggest that the data is organized in groups or sets, which may become one aspect of the retrieval parameter. “Data” may be a broad term that could encompass various types of information, potentially requiring to consider multiple data categories. “Routers” specifies the subject matter, which may narrow down the search domain significantly. In another example discussed above, the input descriptor “2020 resource utilization by region” may specify the retrieval parameters such as a time period, performance metric, and geographical breakdown.

In some cases, the input descriptor indicating the retrieval parameter may be directly considered for data retrieval by the processor 104. Considering the above example, the processor 104 may determine the retrieval parameter as “batches data of Routers” In other cases, the processor 104 or the data analysis unit 402 may parse the input descriptor to extract these individual elements and construct the appropriate retrieval parameter. Considering the above example, the processor 104 may determine the retrieval parameter as “batches” “data” “router”.

Thus, the retrieval parameter may be an information, for example, an identifier, feature, characteristic, nature of data, or other relevant attributes that help identify and locate the required information within the data intelligence repository 108. This information may encompass various aspects of the desired data, serving as a guide for the data retrieval process. Also, in some cases, the retrieval parameter may be a direct representation of the input descriptor, while in others, it may be derived or inferred from the input descriptor through analysis. For example, the processor 104 may employ various techniques to interpret and process the input descriptor for generating more refined retrieval parameters. In some implementations, the processor 104 may utilize the computational model 106 to analyze the input descriptor, allowing for handling of complex or ambiguous inputs. This may potentially improve the accuracy and relevance of the retrieved data.

Further, the processor 104 or the data analysis unit 402 may parse the plurality of datasets 202 available in the data intelligence repository 108 to identify a set of relevant data based on the retrieval parameter. The set of relevant data may be, for example, one or more datasets from amongst the plurality of datasets 202 available in the data intelligence repository 108. In another example, the set of relevant data can also be a portion of one or more of the datasets 202. The set of relevant data may be identified by deriving at least one of semantic inference and contextual inference between the retrieval parameter and the datasets 202 available in the data intelligence repository 108.

In one example, the processor 104 may query the data intelligence repository 108 with the retrieval parameter to identify one or more datasets from amongst the datasets 202 available in the data intelligence repository 108. As discussed above, each of the dataset 202 may have a data tag associated therewith. In one example, the processor 104 may parse datasets 202 available in the data intelligence repository 108 by analyzing the data tags associated with each dataset. For example, for the retrieval parameter “2020 resource utilization by region”, the processor 104 may break it down into key components: time period (2020), performance metric (resource utilization), and geographical aspect (by region). The processor 104 may then compare these components against the data tags of available datasets 202, looking for semantic and contextual matches. In another example, the processor 104 can also compare these components against the content included in the available datasets 202.

For semantic inference, the processor 104 may search for exact or closely related terms in the data tags. For example, the processor 104 may determine semantic conformity between the retrieval parameter and each of the plurality of data tags and identify a set of data tags from amongst the plurality of data tags semantically conforming with the retrieval parameter. To identify the set of data tags, in one example, the processor 104 may compute a semantic similarity score for quantifying a semantic conformity between the retrieval parameter and each of the plurality of data tags. Based on the degree of semantic conformity or similarity, the processor 104 may assign the semantic similarity score to each pair comprising the retrieval parameter and a data tag (which is being checked for semantic conformity). The processor 104 may use techniques such as word embeddings or other semantic analysis methods to measure the degree of semantic similarity between the retrieval parameter and the data tags linked with the datasets 202. For example, the processor 104 may use word embeddings such as Word2Vec, GloVe, or FastText to represent words in high-dimensional vector spaces, where semantically similar words or phrases are positioned closer together. This may enable the processor 104 to identify data tags, or datasets, whose content includes terms that are semantically related to the retrieval parameter, even if the exact terms used in the query do not directly appear in the dataset. For instance, a retrieval parameter of “resource utilization” would allow the processor 104 to find data tags or datasets that contain semantically related terms like “resource allocation”, “resource efficiency”, and “asset utilization”.

Further, the scoring may be performed using similarity metrics such as cosine similarity or Euclidean distance, which quantitatively measure the closeness between the vector representations of the retrieval parameter and the data tags. The semantic similarity score may quantify how closely a dataset's tag aligns with the retrieval parameter. The processor 104 may then compare the semantic similarity score with a threshold similarity score to identify the set of data tags, from amongst the plurality of data tags, semantically conforming with the retrieval parameter. In one example, the threshold similarity score may be defined by the user through the workstation 110. Based on the comparison, the processor 104 may identify the set of data tags semantically conforming with the retrieval parameter. For example, only the pairs of retrieval parameters and the data tag having the semantic similarity score more than the threshold similarity score may be identified to be semantically conforming.

That is, the processor 104 may compute these similarity scores for every dataset's tag and compare them with the threshold similarity score. Datasets with data tags that show a similarity score above the threshold are then considered semantically inferring to the retrieval parameter. For instance, datasets with data tags such as “2020,” “resource utilization,” or “regional data” may be identified as semantically conforming with the retrieval parameter “2020 resource utilization by region”. The processor 104 may then identify the dataset linked with each data tag in the set of data tags.

In one example, the processor 104 may also derive contextual inference which may allow the processor 104 to understand the broader meaning and context of the retrieval parameter in relation to the datasets 202 stored in the data intelligence repository 108. Contextual inference goes beyond simple semantic matching by considering the relationships and dependencies between terms within the retrieval parameter and the context in which those terms appear. This enables the processor 104 to identify datasets that not only match individual terms but also align with the broader context conveyed by the retrieval parameter.

For contextual inference, the processor 104, in one example, may break down the retrieval parameter into its constituent elements. For example, if the retrieval parameter is “2020 resource utilization by region,” the processor 104 may parse it into the following components: time period (“2020”), performance metric (“resource utilization”), and geographical breakdown (“by region”). These components may provide the basis for the contextual analysis, as they define the key aspects of the data being sought. The processor 104 may then identify the relevant contextual factors associated with each component. Contextual inference depends on understanding how the components of the retrieval parameter interact. For instance, the time period “2020” suggests that the processor 104 should focus only on datasets that are relevant to that year, excluding data from other years. Similarly, the performance metric “resource utilization” directs the processor 104 to seek datasets that focus on resource usage, rather than unrelated metrics like production or sales. Finally, the geographical context “by region” requires the processor to focus on datasets that contain regional breakdowns, either at a global, national, or more granular level.

The processor 104 may then examine the data tags associated with the datasets 202 in the data intelligence repository 108. By matching the contextual elements of the retrieval parameter with the data tags, the processor 104 may determine which datasets align with the broader context of the retrieval parameter. For example, datasets with data tags such as “2020,” “resource utilization,” or “regional data” would be identified as contextually relevant, while datasets lacking these contextual components would be excluded.

Further, to quantify how well a dataset aligns with the contextual components, the processor 104 may compute a contextual similarity score. which may reflect how closely the dataset matches the temporal, metric, and geographical context indicated by the retrieval parameter. Datasets that reflect the same contextual relationships-such as those that match both the time period “2020” and the metric “resource utilization”-will receive higher contextual similarity scores. In contrast, datasets that only match part of the context or lack relevant contextual information may be assigned lower scores.

Once the contextual similarity scores are calculated, the processor 104 may compare them against a contextual similarity threshold. In one example, the contextual similarity threshold may be defined by the user through the workstation 110. Datasets that meet or exceed the contextual similarity threshold may be identified as relevant. These datasets may be referred to as the set of relevant data.

In another example, the processor 104 may utilize the computational model 106 for deriving the semantic inference and/or the contextual inference between the retrieval parameter and the datasets 202 available in the data intelligence repository 108. In one example, a trained computational model 106 may deployed on the processor 104. In another example, the computational model 106 may be external to the system 102 or at least the processor 104 and may be communicably linked with the processor 104.

In one example, the processor 104 may trigger the computational model 106 to parse the datasets 202 and derive the semantic inference and/or the contextual inference between the retrieval parameter and the datasets 202 available in the data intelligence repository 108. Upon being triggered, the computational model 106 may, in one example, interpret the retrieval parameter, such as “2020 resource utilization by region,” and extract its key components, such as the time period, performance metric, and geographical breakdown. These components may serve as the basis for the semantic analysis, as the computational model 106 may seek to find datasets from the data intelligence repository 108 whose associated data tags semantically align with these components.

To determine semantic conformity, the computational model 106 may evaluate the data tags of the datasets 202 in the data intelligence repository 108 against the retrieval parameter. Using techniques such as word embeddings, the computational model 106 may quantify the degree of semantic similarity between the retrieval parameter and each data tag. For example, the computational model 106 may use vector space models to measure the distance between the terms in the retrieval parameter and those in the data tags. For example, the scoring may be performed using similarity metrics such as cosine similarity or Euclidean distance, which quantitatively measure the closeness between the vector representations of the retrieval parameter and the data tags. This results in the calculation of the semantic similarity score for each dataset with respect to the retrieval parameter. The semantic similarity score reflects how closely the data tag matches the semantic content of the retrieval parameter.

Once the computational model 106 computes the semantic similarity scores, the computational model 106, or the processor 104, may compare each semantic similarity score against the threshold similarity score. This threshold can be set by the user or defined automatically by the model. Further, the datasets with a semantic similarity score that exceeds the threshold similarity score may be considered semantically inferring to the retrieval parameter. For example, for the above-discussed retrieval parameter, datasets with data tags like “2020,” “resource utilization,” or “regional data” may be identified as semantically relevant. The computational model 106, or the processor 104, may then identify the datasets corresponding to these relevant data tags, ensuring that only datasets that meet the semantic criteria are retrieved. Such datasets may be referred to as the set of relevant data.

Further, for deriving contextual inference, the computational model 106 may understand the relationships and dependencies between the various components of the retrieval parameter and the broader context in which these components exist. The computational model 106 may derives contextual inference by analyzing how the individual elements within the retrieval parameter interact with each other, going beyond simple semantic matching. In one example, in the case of the retrieval parameter “2020 resource utilization by region,” the computational model 106 may break it down into key contextual components: the time period “2020,” the performance metric “resource utilization,” and the geographical aspect “by region.” The computational model 106 may then interpret the broader meaning of these components and determine the relationships that are crucial for identifying contextually relevant datasets. In this case, the computational model 106 may understand that the retrieval process should focus on datasets from the year 2020, related to resource utilization, and broken down by geographical region.

The computational model 106 may then compare the contextual components of the retrieval parameter with the data tags of the datasets 202 stored in the data intelligence repository 108. For example, datasets with data tags like “2020,” “resource utilization,” or “regional data” would be evaluated for how well they align with the specific contextual elements of the retrieval parameter. Contextual similarity may be determined by how well these datasets represent the same temporal, metric, and geographical context outlined by the retrieval parameter.

To quantify the contextual relevance, the computational model 106 may compute the contextual similarity score, which may reflect the degree of alignment between the dataset and the broader context defined by the retrieval parameter. Datasets that fully reflect the temporal, performance, and geographical aspects of the retrieval parameter will have higher contextual similarity scores, while those that do not align as well will have lower scores.

The computational model 106, or the processor 104, may compare the computed contextual similarity scores against the contextual similarity threshold. Datasets that meet or exceed the contextual similarity threshold may be considered contextually inferring the retrieval parameter. For example, datasets that match both the time period “2020” and the metric “resource utilization” and contain relevant geographical data would be retrieved as part of the set of relevant data. Thus, the computational model's ability to understand and process the contextual relationships between components ensures that the retrieved datasets are not only semantically accurate but also contextually appropriate.

Further, the above discussed examples, according to one implementation, disclose analyzing semantic similarity and contextual similarity between data tags and the retrieval parameter, and accordingly identifying one or more dataset, being referred to as the set of relevant data. However, other approaches may also be possible. For example, instead of data tags, the processor 104 or the computational model 106 may directly analyze the content of the datasets 202 to derive the semantic and contextual inference between the content of such datasets 202 and the retrieval parameter. Such derivation may be similar to the derivations discussed above. For example, for the above-discussed retrieval parameter, the datasets with content including terms like “2020,” “resource utilization,” or “regional data” may be identified as semantically inferring. Similarly, for deriving contextual inference, the datasets with content including terms like “2020,” “resource utilization,” or “regional data” would be evaluated for how well they align with the specific contextual elements of the retrieval parameter. Based on the evaluation, the datasets contextually inferring the retrieval parameters may be identified.

Further, in one example, the processor 104 itself, or by utilizing the computational model 106, may derive at least one of the semantic and contextual inferences between the retrieval parameter and the datasets 202, as discussed above. In another example, the processor 104 itself, or by utilizing the computational model 106, may derive both, i.e., the semantic and contextual inferences between the retrieval parameter and the datasets 202, as discussed above. For example, contextual inference may be derived or determined between the retrieval parameter and the datasets 202, or their data tag, to identify a candidate set of relevant data. Then, the semantic inference may be derived or determined between the candidate set of relevant data and the retrieval parameter to further identify a filtered set of data, i.e., the set of relevant data. Alternatively, the semantic inference may be derived or determined between the retrieval parameter and the datasets 202, or their data tag, to identify a candidate set of relevant data. Then, the contextual inference may be derived or determined between the candidate set of relevant data and the retrieval parameter to further identify a filtered set of data, i.e., the set of relevant data.

Once the set of relevant data is identified, the processor 104, or the data management unit 404, may execute an adaptive data segmentation workflow for the set of relevant data. In one example, the adaptive segmentation workflow may be a set of operations or processes that may be performed by the processor 104 to manage the distribution of the set of relevant data amongst one or more segments. Each segment may be, for example, a section, a chapter, or one or more pages. In one example, the one or more segments may collectively form a record, file, or a digital document.

The distribution may be managed based on at least one of a prescribed computational data dimension threshold, a semantic relationship between data in the set of relevant data, and a data partitioning schema derived based on partitioning of data indicated by a set of records historically recorded.

For managing the distribution of data based on prescribed computational data dimension threshold, the processor 104 may partition the identified set of relevant data according to the prescribed computational data dimension threshold. The prescribed computational data dimension threshold may be based on various data dimensions, for example, the size of the data, horizontal length of data, number of rows and/or columns, or the number of data points. For instance, if the prescribed computational data dimension threshold is defined by a size limit, such as a range of up to 500 text characters, the processor 104 may divide the identified set of relevant data into segments that conform to this threshold. The processor 104 may evaluate the retrieved datasets (or the set of relevant data) and check their total size, which could be in the form of text characters, numbers, or other measurable units. Once the data size reaches the prescribed threshold (in this case, 500 text characters), the processor 104 may partition the data, ensuring that each segment does not exceed the specified limit. For example, if the set of relevant data consists of a large dataset that exceeds the threshold of 500 characters. The processor 104 may segment it, ensuring each segment does not surpass 500 characters. The segmentation process might involve the processor 104 splitting the dataset based on logical boundaries, such as sentence or paragraph breaks, or simply dividing the content into equal character blocks. Each segment thus generated will be smaller than or equal to the prescribed data dimension threshold.

In another example, in cases where the prescribed computational data dimension threshold is defined by the number of data points, such as a specified number of records or data entries, the processor 104 may partition the data into segments containing no more than the prescribed number of data points. For instance, if the threshold is set to 50 data points, the processor 104 will ensure that no segment contains more than 50 individual data points. This allows the processor 104 to organize the data in a manageable format for the record, ensuring that each segment adheres to the defined constraint, whether based on size or data count.

In another example, in cases where the prescribed computational data dimension threshold is defined by the number of rows (for example, rows of data or rows in a table), the processor 104 uses this threshold to partition the set of relevant data into segments, ensuring that each segment contains a specified number of rows. For instance, if the threshold is set to 20 rows, the processor 104 will analyze the identified set of relevant data (which may be structured as a table) and ensure that no segment contains more than 20 rows. The processor 104 may first examine the total number of rows in the retrieved table, and if it exceeds the threshold, the processor 104 may partition the data or table into multiple segments where each segment consists of 20 or fewer rows. Each segment will be a subset of the original table, containing a contiguous block of rows. By dividing the table data based on the number of rows, the processor 104 ensures that the segments are manageable, conforming to the prescribed threshold per segment. Such segmentation may make it easier to handle the data for the record, especially for tasks such as processing, analysis, or exporting the table in smaller, more manageable parts.

Such row-based partitioning approach may particularly be useful for working with large datasets stored in tables, such as in databases or spreadsheets. It enables the processor 104 to efficiently manage large tables by breaking them down into smaller, more manageable segments, while maintaining the integrity and structure of the original data. The approach also helps in optimizing storage or further processing operations on large datasets by ensuring each segment adheres to the desired row limit, which can improve performance and scalability. Further, the prescribed computational data dimension threshold may help in better space utilization in the record.

Similarly, there may be other data distribution management criteria that may be defined as the prescribed computational data dimension threshold for managing the set of relevant data into segments based on the dimensions of the data. In one example, such a prescribed computational data dimension threshold may be defined by the user through the workstation 110 to comply with the user needs or organizational needs. In another example, the processor 104 may itself define such a prescribed computational data dimension threshold. For example, if each segment may be a page of the record, based on the dimensions of the page (such as standardized paper sizes A4, A5, A3, and the like), the processor 104 may define the prescribed computational data dimension threshold such that each page may have efficiently managed content, thereby leading to better space utilization. Similarly, the processor 104 can determine the prescribed computational data dimension threshold based on various factors, for example, dimensions of slide, size of screen on which the segment or record is to be rendered, or screen layout.

In one example, the processor 104 may determine the prescribed computational data dimension based on such factors based on a mapping table prescribing the threshold for a wide range of page dimensions, screen layouts, slide dimensions, and screen sizes. The mapping table may include entries for a wide range of page dimensions, screen layouts, slide dimensions, and screen sizes. For each combination of these factors, the table prescribes a specific threshold or range of thresholds that have been determined to be optimal for data partitioning. For example, the mapping table might be structured as follows:

| Output Format | Dimensions | | Prescribed Threshold |
|---|---|---|---|
| A4 Page | 210 × 297 | mm | 500 characters or 20 rows |
| Smartphone Screen | 375 × 667 | px | 200 characters or 10 rows |
| Presentation Slide | 1920 × 1080 | px | 300 characters or 15 rows |

When the processor 104 needs to determine a threshold, it can refer to the mapping table. The processor 104 may identify the relevant parameters (such as the output format and dimensions) and look up the corresponding prescribed threshold. Such approach may allow for quick and consistent threshold determination across various scenarios. The mapping table can be expanded to include additional factors such as content type, user preferences, or device capabilities. It may also incorporate ranges or formulas instead of fixed values, allowing for more nuanced threshold selection.

In one example, the processor 104 may determine the prescribed computational data dimension threshold by analyzing he dimensions of a target display medium, such as a screen, page, or slide, calculating the available space for content presentation and setting the threshold accordingly to ensure optimal use of the space. The processor 104 may also evaluate the type of content being processed (e.g., text, tables, images) and adjust the threshold based on the typical requirements for that content type.

In one example, the processor 104 can also maintain a database of previously used thresholds and their effectiveness. By analyzing such historical data, the processor 104 may identify patterns and determine optimal thresholds for similar types of content or display scenarios. Dynamic adjustment may be another approach used by the processor 104. It may start with an initial threshold and dynamically adjust it based on the actual content being processed. If it detects that the current threshold is resulting in suboptimal segmentation, it may iteratively refine the threshold until a satisfactory distribution is achieved. The processor 104 may also assess the complexity of the content, such as the density of information or the intricacy of data relationships, and set thresholds that ensure each segment contains a manageable amount of information. The processor 104 may also implement an adaptive thresholding mechanism that adjusts the threshold based on the characteristics of the current dataset. This could involve statistical analysis of the data distribution to identify natural break points or clusters. By employing these methods, the processor 104 can autonomously determine and refine the prescribed computational data dimension threshold, adapting to various content types, display scenarios, and user or organizational needs without requiring manual input for each instance. This approach allows for flexible and efficient data partitioning that can adapt to different output formats and display requirements, ultimately enhancing the user experience and optimizing data presentation across various contexts.

In another example, the distribution of the set of relevant data may be managed amongst the one or more segments based on the semantic relationship between data in the set of relevant data. Each of the one or more segments may be derived based on semantic distinctiveness between data in the set of relevant data. Each derived segment may comprise semantically dissimilar data from the set of relevant data. In one example, the processor 104, or the processor 104 by utilizing the computational model 106, may manage the distribution of the set of relevant data across one or more segments based on the semantic relationships between the data elements within the set of relevant data. This process may involve using NLP techniques such as latent semantic analysis (LSA) or word2vec to quantify semantic relationships. The distribution may be to ensure that each segment contains data that is semantically distinct or dissimilar from the others, allowing for more effective organization and analysis of the data.

The processor 104 or computational model 106 may analyze the set of relevant data for semantic relationships among the individual data elements. For example, in the context of tabular data, this could mean identifying relationships between the rows or columns of a table. Each row (or set of data points) may be analyzed for the semantic themes it represents, such as time periods, geographic locations, types of metrics, etc. If the relevant data consists of textual data or metadata, the processor 104 or the computational model 106 may use techniques, for example, word embeddings, semantic similarity, or entity recognition to understand the inherent meaning of the data.

Once the processor 104 or computational model 106 has parsed the semantic meanings of the data elements, it can evaluate the degree of semantic similarity between the different elements. For example, in a table of data where each row represents a set of performance metrics, the processor 104 may assess how closely related each row is to others based on the underlying semantic themes. Suppose the set of relevant data comprises a first row “2020 resource utilization by region”, a second row “2020 sales performance by region”, a third row “2021 resource consumption by region”, and a fourth row “2021 customer satisfaction by region”. The processor 104 or computational model 106 may compute semantic similarity scores between these rows. The processor 104 or computational model 106 may compute a semantic similarity score for pairs of data elements (pair of rows) to assess how closely related they are in meaning. This computation may involve, for example, calculating cosine similarity between vector representations of the rows, or using more sophisticated metrics like Word Mover's Distance for textual data. Data elements that are highly semantically related may be grouped together, while data elements that are more semantically distinct may placed in separate segments. For example, the first and third rows, which both involve resource utilization, would have a high semantic similarity score because they share the same theme of resource usage. In contrast, the second and fourth rows are related to different themes-sales performance and customer satisfaction-so they will have a lower semantic similarity score when compared to the first and third rows. This helps the processor 104 or the computational model 106 to identify that the first and third rows are more semantically aligned with each other, while rows 2 and 4 are semantically distinct from them.

Similarly, the processor 104 can segment the relevant set of data based on the geographic location or other similar criteria. This segmentation may be implemented using clustering algorithms such as K-means or hierarchical clustering, with the number of clusters determined dynamically based on the data distribution. This way, the processor 104 may distinguish between rows that belong together based on their semantic themes, ensuring that the data is segmented according to their meaning. By distributing data into segments based on semantic relationships, the processor 104 may ensure that each segment represents a coherent set of data. This makes it easier to access, analyze, and interpret data because similar concepts are grouped together. For example, if resource utilization data is grouped based on the geographic location of resource utilization, or grouped separately from sales data, it ensures that users or systems analyzing the data can focus on more streamlined information. Further, segmenting data by semantic dissimilarity ensures that the context around each data point is preserved. For example, mixing rows about “sales” with rows about “resource utilization” might obscure the true context of each dataset. By grouping semantically similar data together, the processor 104 may ensure that the meaning and context are maintained, improving the quality of analysis and decision-making.

Further, when data is grouped by semantic similarity, forward processing of data may be enhanced. For example, it may become easier to apply more advanced data analysis techniques, such as machine learning, clustering, or pattern recognition. These techniques often rely on the assumption that data points within a group share common characteristics. By segmenting data semantically, the processor 104 may thus enable advanced techniques to perform more effectively, leading to more accurate insights. Furthermore, when semantically distinct data is kept in separate segments, the signal (i.e., meaningful patterns and trends) is less likely to be drowned out by unrelated “noise.” For example, resource utilization trends will be easier to identify in a segment that is dedicated solely to resource utilization, compared to a dataset that mixes resource utilization with other unrelated data. This improves the quality of insights derived from the data.

Further, in another example, the distribution of the set of relevant data may be managed amongst the one or more segments based on the data partitioning schema derived based on partitioning of data indicated by the set of records historically recorded. Each of the one or more segments may be derived by distributing the data, in the set of relevant data, based on the data partitioning schema. Examples of the historical records may include, but are not limited to, analytical reports, a set of web pages, computer program associated with the set of web pages, review reports, annual product quality review (APQR) reports, finance-related statements, sales reports, datasheets, Food and Drug Administration (FDA) reports, manuals, catalogs, editable computer-readable files, drawings, and the like. In one example, the historical records may also be a collection of multiple documents. The historical records may include, for example, textual and non-textual records. In one example, the historical records may be stored in the data intelligence repository 108.

The processor 104 may analyze historical records to identify common patterns in how data was previously partitioned. This analysis may involve techniques such as frequency analysis of partitioning criteria used in past records, statistical analysis of data distribution across different partitions, and machine learning algorithms to detect recurring partitioning patterns. For example, if the set of records historically recorded typically separated data by resource category, such a schema may be applied to create segments for different resource categories. The processor 104 may implement this by identifying distinct resource categories present in the current set of relevant data, creating separate segments for each identified resource category, and assigning data points to appropriate segments based on their associated resource category. In another example, the historical records might show a pattern of partitioning data based on time periods. The processor 104 could then implement a time-based partitioning schema, creating segments for different time intervals (e.g., daily, weekly, monthly, or yearly) and distributing the current data accordingly.

Additionally, the processor 104 might identify a pattern of geographical partitioning in historical records. In this case, the processor 104 may create segments based on geographic regions or locations, assigning data points to the appropriate geographical segment. The processor 104 could also detect more complex partitioning patterns, such as a combination of multiple criteria. For instance, historical records might show a pattern of partitioning data first by resource category, then by time period within each category. Such approaches may ensure consistency with historical data organization practices, potentially facilitating easier integration with existing systems and analysis workflows.

Different techniques or approaches may be utilized by the processor 104 to partition the data based on the historical records, or the schema derived based on such historical records. For example, to identify common partitioning criteria in the historical records, the processor 104 may use, for example, machine learning algorithms such as decision trees or random forests. Further, techniques like K-means clustering or hierarchical clustering could be used to group similar partitioning schemas found in historical records, helping to identify the most prevalent approaches. Furthermore, if historical records include textual descriptions of partitioning methods, NLP techniques could be used to extract and categorize these methods. The processor 104 may also perform time series analysis for identifying temporal patterns in partitioning schemas, especially if partitioning methods have evolved over time. The processor 104 may also semantic analysis to understand the meaning and context of different data fields, helping to make more informed partitioning decisions.

Thus, various approaches may be utilized by the processor 104 for analyzing the historical records and understanding the partitioning logics used therein. The processor 104 may also employ adaptive techniques to refine the partitioning schema over time. This could involve monitoring the effectiveness of the current partitioning schema, adjusting the schema based on new patterns observed in recent data, and incorporating user feedback on the usefulness of the current segmentation.

Further, the processor 104, or the signal generation unit 406, may generate a record generation signal to indicate each of the one or more segments comprising data from the set of relevant data. In one example, the record generation signal may be a signal, a set of instructions, or metadata indicating the partitioning schema, i.e., the data (from the set of relevant data) corresponding to each of the one or more segments.

Further, by generating the record generation signal, the processor 104 may indicate of each of the one or more segments with the data from the set of relevant data. For example, each of the one or more segments, such as one or more of the segments 512-1 and 512-2 may be indicated on the graphical user interface 502. Each segment may represent the data, from the set of relevant data, associated with it. Though not illustrated, the graphical user interface 502 can include more segments. As the graphical user interface 502 may be rendered on the display device of the workstation 110, the user may be able to access the one or more segments, for example, by interacting or scrolling over the graphical user interface 502 or the processing panel 510.

Further, in one example, the processor 104 may cause generation of a record comprising the one or more segments. In response to generation of the record generation signal, the processor 104 may, for example, collate or order each of the one or more segments and generate the record. In one example, the record may be a machine-readable file or document that may be formed by the collection of one or more segments.

The processor 104 may cause rendering of a graphical user interface, such as a graphical user interface 600 illustrated in FIG. 6, to indicate the record with the one or more segments comprising data from the set of relevant data. FIG. 6 illustrates a block diagram of the graphical user interface 600 comprising a record 602, according to one example implementation of the present subject matter. In one example, generation of the record generation signal may the processor 104 to generate the record and cause rendering of the graphical user interface 600 on the display device of the workstation 110. As illustrated, the record may comprise the segments 512-1, 512-2, . . . , and 512-X, where X is a natural number. Each of the segments 512-1, 512-2, . . . , and 512-X may comprise data linked therewith through the adaptive data segmentation workflow, as discussed above. Thus, the user may be presented with the segments, where each segment may comprise data linked with that segment. Each segment may be, for example, a page or a set of pages of the record 602. In another example, each segment may form a section or a chapter, comprising data linked with that segment, of the record 602.

Thus, the processor 104 may cause generation of the record 602 comprising the one or more segments, thereby presenting information or data in a managed and more focused manner. Segmented data enhances the user experience by presenting information in discrete, logically organized segments, such as pages, sections, or chapters, each containing relevant data. This segmentation allows users to quickly navigate and access specific subsets of data without the need to sift through a larger, potentially overwhelming dataset. This approach improves clarity, increases efficiency in accessing information that could be critical, and reduces cognitive load, making it easier for users to interact with complex records and datasets.

Further, in one example, the processor 104 may cause rendering of one or more interactable components for each of the one or more segments. In one example, the one or more interactable components may comprise at least one of a first interactable component 604, a second interactable component 606, and a third interactable component 608, as illustrated in FIG. 6. Such one or more interactable components may be rendered for each of the one or more segments, as illustrated in FIG. 6.

In one example, each of the interactable components may be an interactable graphical component, such as a clickable button, rendered on the graphical user interface 600. The user may be able to interact with the interactable components, for instance, through the workstation 110. In one example, the first interactable component 604 may be rendered to receive a positive feedback for a segment with which it is linked, such as the segment 512-1. The positive feedback may indicate acceptance of the data linked with that segment 512-1. Whereas, the second interactable component 606 may be rendered to receive a negative feedback for a segment with which it is linked, such as the segment 512-1. The negative feedback may indicate erroneous distribution of data linked with that segment 512-2. That is, negative feedback may indicate that the data linked with that segment is erroneous or unacceptable. Further, the third interactable component 608 may be rendered to receive a modification feedback for a segment with which it is linked, such as the segment 512-1. The modification feedback may indicate, in one example, a request for modifying the data linked with that segment 512-1.

On receiving the modification feedback, the user may be allowed to interact with the data linked with the segment 512-1 through the workstation 110 to modify the data. Such modification may include, for example, deletion and addition of data, restructuring of data, and even addition of data from one segment to another segment. Thus, the graphical user interface 600 may not only allow acceptance or rejection of the data distribution but may also allow modification of the data, thereby providing flexibility to modify the data or distribution of data as per the user's need or organizational needs.

Further, once the modification is done, the processor 104 may cause generation of a modified record comprising a modified instance of the data linked with that segment. That is, once the modifications are made, the processor 104 may generate a modified record, which may include the new instance of the data reflecting the changes made to the original segment. This may provide greater flexibility and a manual failsafe mechanism, ensuring that the data can be updated to meet specific requirements.

Further, as discussed above, the distribution of the set of relevant data may be based on at least one of the prescribed computational data dimension threshold, the semantic relationship between data in the set of relevant data, and the data partitioning schema. In one example, the selection of how the distribution of the set of relevant data is to be implemented, may be determined based on an input of the user received from through the workstation 110. For example, the user may provide an input, for example through the interactive interface 500, indicating whether the distribution should be based on the prescribed computational data dimension threshold, the semantic relationship between data in the set of relevant data, or the data partitioning schema.

In another example, the processor 104 may itself determine how the distribution may be implemented. For example, based on the content or data present in the set of relevant data, the processor 104 may opt for at least one of the above-discussed data distribution approaches. For example, if the processor 104 determines that distribution of data based on semantic relationships may lead to better segmentation of data or better space utilization in the record 602, the processor 104 may opt for distributing the set of relevant data based on the semantic relationships.

Similarly, in another example, if the processor 104 determines, based on the set of relevant data, that distribution based on the prescribed computational data dimension threshold may lead to better segmentation of data or better space utilization in the record 602, the processor 104 may opt for distributing the set of relevant data based on the prescribed computational data dimension threshold. For example, if the set of relevant data is large or lengthy such that identifying semantic relationships may be, for instance, difficult or draining from computing resource perspective, the processor 104 may opt for a comparatively simplified distribution of the set of relevant data based on the prescribed computational data dimension threshold. For example, if the set of relevant data includes more than 1 million characters or may have a collective size of more than 1 terabyte, the processor 104 may opt for distributing the set of relevant data based on the prescribed computational data dimension threshold. Thus, when dealing with large or resource-intensive data, distributing based on computational data dimension thresholds may offers a simplified and less computationally demanding solution, enabling effective data management without overburdening resources.

Similarly, in one example, in case the set of relevant data may include complex data, the processor 104 may refer to the data partitioning schema instead of distributing the data based on semantic relationships or prescribed computational data dimension threshold. For instance, in complex data scenarios, such as graphs and images, the processor 104 may opt to refer to the data partitioning schema to determine how such data may be handled for distribution. Using the data partitioning schema may allow the processor 104 to optimize data handling, providing a structured approach to distribute such data effectively, even under intricate conditions.

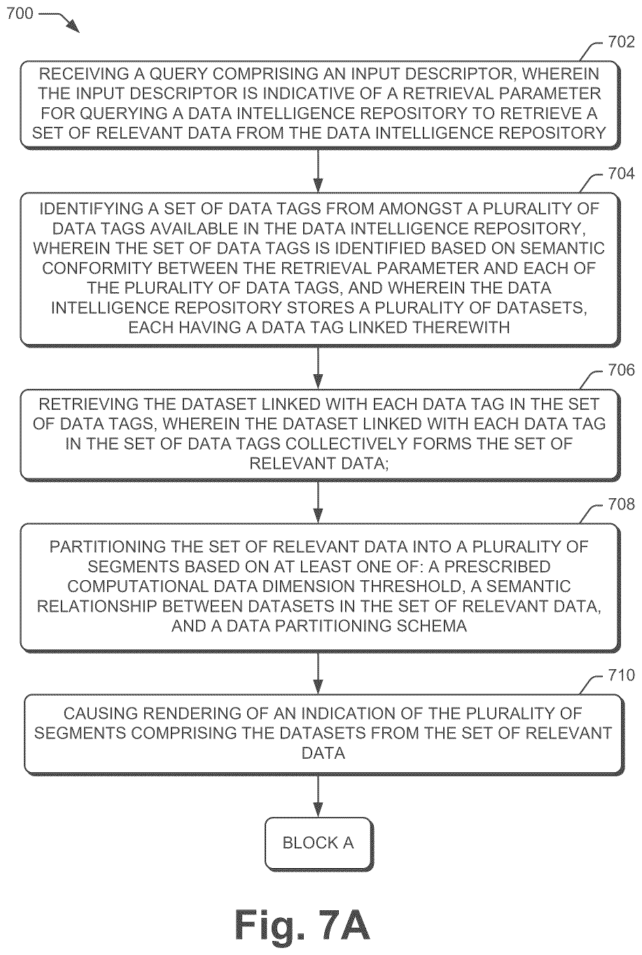

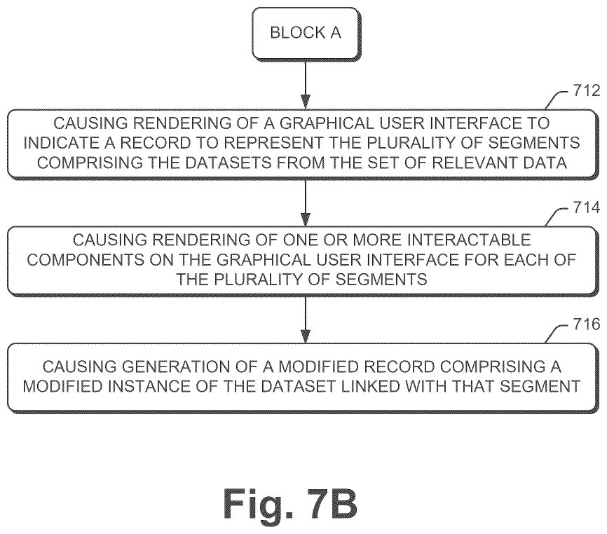

FIGS. 7A and 7B illustrate a block diagram of an exemplary method 700 for managing distribution of data, according to one example implementation of the present subject matter. The order in which the method 700 is described is not intended to be construed as a limitation, and any number of the described method blocks may be combined in any order to implement the method 700, or an alternative method. Furthermore, method 700 may be implemented by processing resource or computing device(s) through any suitable hardware, non-transitory machine-readable instructions, or combination thereof.

It may also be understood that method 700 may be performed by programmed computing devices, such as the processor 104, as depicted in FIGS. 1A-4. Furthermore, the method 700 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. While the method 700 is described below with reference to the processor 104 and the system 102 as described above; other suitable systems for the execution of these methods may also be utilized. Additionally, the implementation of these methods is not limited to such examples.

At block 702, a query comprising an input descriptor may be received. As discussed in one example, the query may be received from an interactive interface, such as the interactive interface 500 as discussed above with reference to FIGS. 5A to 5C. In one example, the query may be generated by the interactive interface in response to receiving the input descriptor. For example, upon receiving the input descriptor, the interactive interface may generate the query that may comprise the input descriptor that has been received.

As discussed above, in one example, the input descriptor may be a text-based query. In another example, the input descriptor may be a data object that may be submitted by the user, as discussed above. Further, the input descriptor may be indicative of a retrieval parameter for querying a data intelligence repository, such as the data intelligence repository 108, to retrieve a set of relevant data from the data intelligence repository. For instance, as the input descriptor provides information about the data which is to be retrieved, it may effectively indicate the retrieval parameter. That is, the input descriptor may serve as a key indicator for the retrieval parameter, effectively guiding the data retrieval process.

In some aspects, the input descriptor may encapsulate specific details or characteristics of the desired information that is to be retrieved. Such specific details or characteristics may be referred to as the retrieval parameters, as discussed above in various examples. However, in some cases, the input descriptor may be directly considered for data retrieval. In such cases, the input descriptor may, thus, itself act as the retrieval parameter as it may be used for querying the data intelligence repository and retrieving a set of relevant data. Thus, the retrieval parameter may be any information, for example, an identifier, feature, characteristic, nature of data, or other relevant attributes that help identify and locate the data within the data intelligence repository. This information may encompass various aspects of the desired data, serving as a guide for the data retrieval process.

At block 704, a set of data tags from amongst a plurality of data tags available in the data intelligence repository may be identified based on the retrieval parameter indicated by the received input descriptor. As discussed above, the data intelligence repository may comprise the plurality of datasets 202, where each data set may have a data tag linked therewith. In one example, the data tags may contain textual data indicating the characteristics or attributes of the data contained within the dataset with which they are linked, a descriptive identifier for the dataset, an assigned name for the dataset, and the like.

Further, based on the retrieval parameter, the set of data tags may be identified. In one example, identification of the set of data tags may be based on semantic conformity between the retrieval parameter and the data tags available in the data intelligence repository. As discussed above, a semantic similarity score may be computed to quantify the semantic conformity between the retrieval parameter and each of the plurality of data tags. For example, techniques such as word embeddings or other semantic analysis methods may be used for computing the degree of semantic similarity between the retrieval parameter and the data tags linked with the datasets. For example, word embeddings such as Word2Vec, GloVe, or FastText may be used to represent words in high-dimensional vector spaces, where semantically similar words or phrases are positioned closer together. This may enable identification of data tags whose content includes terms that are semantically related to the retrieval parameter, even if the exact terms used in the query do not directly appear in the dataset. Further, the scoring may be performed using similarity metrics such as cosine similarity or Euclidean distance, which quantitatively measure the closeness between the vector representations of the retrieval parameter and the data tags. The semantic similarity score may quantify how closely a dataset's tag aligns with the retrieval parameter.

The semantic similarity score, computed for each pair comprising the retrieval parameter and a data tag, may then be compared with a threshold similarity score to identify the set of data tags, from amongst the plurality of data tags, semantically conforming with the retrieval parameter. Based on the comparison, one or more data tags, referred to as the set of data tags, the set of data tags semantically conforming with the retrieval parameter may be identified.

At block 706, the dataset linked with each data tag in the set of data tags may be retrieved from the data intelligence repository. As discussed above, each data tag may be linked with a dataset available or stored in the data intelligence repository. Based on the data tag, the dataset corresponding to the data tag may be located within the data intelligence repository and retrieved from the data intelligence repository. The dataset linked with each data tag in the set of data tags may collectively form the set of relevant data.

At block 708, the set of relevant data may be partitioned into a plurality of segments. In one example, the partitioning may be based on at least one of a prescribed computational data dimension threshold, a semantic relationship between datasets in the set of relevant data, and a data partitioning schema derived based on partitioning of datasets indicated by a set of records historically recorded. Each segment may be, for example, a section, a chapter, or one or more pages, as discussed above. In one example, the plurality of segments may collectively form a record, such as the record 602.

For partitioning data based on prescribed computational data dimension threshold, the identified set of relevant data may be partitioned according to the prescribed computational data dimension threshold, as discussed above. The prescribed computational data dimension threshold may be based on various data dimensions, for example, the size of the data, horizontal length of data, number of rows and/or columns, or the number of data points. The plurality of segments may be derived by partitioning the set of relevant data based on the prescribed computational data dimension threshold. For example, the set of relevant data may be split based on the prescribed computational data dimension threshold, as discussed above.

Further, in one example, the partitioning of data may be based on the semantic relationship between datasets in the set of relevant data. In one example, the computational model 106 may be utilized for partitioning the set of relevant data across the plurality of segments based on the semantic relationships between the datasets in the set of relevant data, as discussed above. The computational model 106 may be, in one example, an NLP model capable of quantifying the semantic relationships or themes between the datasets, as discussed above.

For example, each dataset may comprise textual content. In such a scenario, semantic relationships between the textual content may be identified. The textual content of each dataset may be analyzed for the semantic themes it represents. Once the semantic theme of the datasets is determined, the degree of semantic similarity may be evaluated between the different datasets, or their textual content. Datasets having textual content that are highly semantically related may be grouped together, while datasets with semantically distinct content may be placed in separate segments. Thus, each of the plurality of segments may be derived based on semantic distinctiveness between the datasets in the set of relevant data, where each derived segment comprises semantically dissimilar datasets. Such partitioning may ensure that each segment contains data or datasets that are semantically distinct or dissimilar from the others, allowing for more effective organization and analysis of the data.

Further, in one example, the partitioning of data may be based on the data partitioning schema derived based on partitioning of datasets indicated by the set of records historically recorded. Each of the one or more segments may be derived by distributing the datasets, in the set of relevant data, based on the data partitioning schema. The historical records may be analyzed to derive the data partitioning schema, as discussed above. For instance, patterns indicating how data was previously partitioned may be derived. For example, if the set of records historically recorded typically separated data by resource category, such a schema may be applied to create segments for different resource categories. Similarly, various data partitioning schemas can be derived by analyzing the set of record historically generated or recorded.

At block 710, rendering of an indication of the plurality of segments comprising datasets from the set of relevant data may be caused. In one example, rendering of a graphical user interface, such as the graphical user interface 502 or the processing panel 510, may be caused on a workstation, such as the workstation 110, to indicate the plurality of segments, where each of the plurality of segments may comprise the dataset linked therewith based on the partitioning.

From block A and block 712, rendering of a graphical user interface may be caused to indicate a record to represent the plurality of segments comprising the datasets from the set of relevant data. In one example, rendering of a graphical user interface, such as the graphical user interface 600, may be caused to indicate the record, such as the record 602, where each segment of the plurality of segments may comprise the dataset linked therewith based on the partitioning. In one example, the record may be a digital file or document that may comprise the plurality of segments. In one example, the graphical user interface may be rendered on the workstation, such as the workstation 110.

At block 714, rendering of one or more interactable components may be caused on the graphical user interface for each of the plurality of segments. As discussed above, the one or more interactable components may comprise at least one of the first interactable component 604, the second interactable component 606, and the third interactable component 608. Such one or more interactable components may be rendered for each of the plurality of segments, as illustrated in FIG. 6.

Each of the interactable components may be an interactable graphical component, such as a clickable button, rendered on the graphical user interface 600. The user may be able to interact with the interactable components, for instance, through the workstation 110. In one example, the first interactable component 604 may be rendered to receive a positive feedback for a segment with which it is linked, such as the segment 512-1. The positive feedback may indicate acceptance of the dataset linked with that segment 512-1, as discussed above. Whereas, the second interactable component 606 may be rendered to receive a negative feedback for a segment with which it is linked, such as the segment 512-1. The negative feedback may indicate erroneous partitioning of dataset linked with that segment 512-2. That is, negative feedback may indicate that the dataset linked with that segment is erroneous or unacceptable.

Further, the third interactable component 608 may be rendered to receive a modification feedback for a segment with which it is linked, such as the segment 512-1. The modification feedback may indicate a request for modifying the dataset linked with that segment 512-1. On receiving the modification feedback, the user may be allowed to interact with the data linked with the segment 512-1 to modify the dataset, as discussed above.

At block 716, generation of a modified record may be caused. The modified record may comprise a modified instance of the dataset linked with that segment. For example, once the modification is done, a modified version of the record may be generated, which may include the new instance of the dataset comprising the changes made to the original dataset. This may provide flexibility and a manual failsafe mechanism, ensuring that the dataset can possibly be fine-tuned, if required, to meet specific requirements.

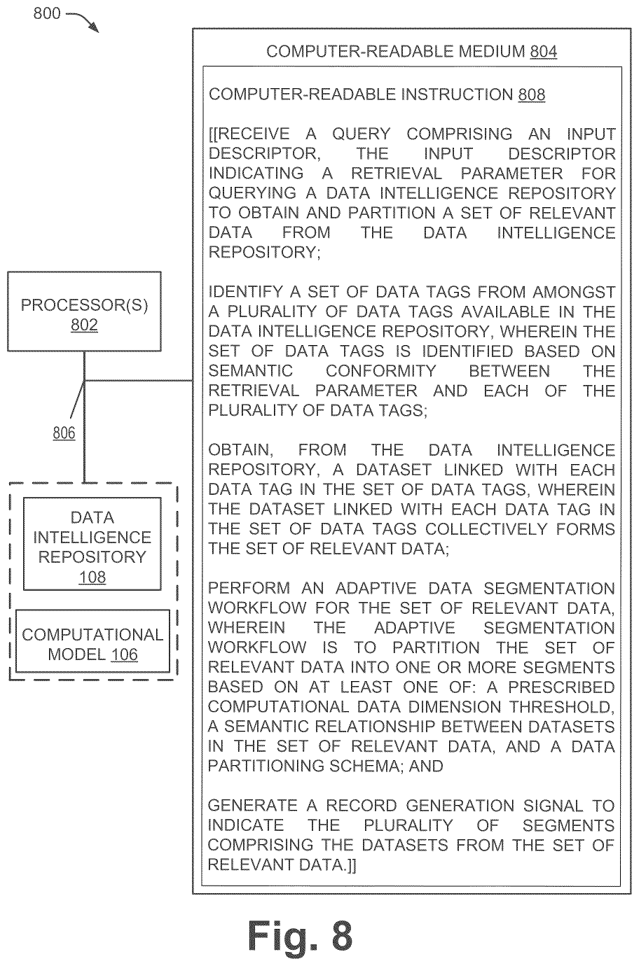

FIG. 8 illustrates a non-transitory computer-readable medium for managing distribution of data, in accordance with an example of the present subject matter. In an example, the computing environment 800 includes a processor 802 communicatively coupled to a non-transitory computer readable medium 804 through communication link 806. In an example, the processor 802 may have one or more processing resources for fetching and executing computer-readable instructions from the non-transitory computer readable medium 804. The processor 802 and the non-transitory computer readable medium 804 may be implemented, for example, in the system 102.

The non-transitory computer readable medium 804 may be, for example, an internal memory device or an external memory. In an example implementation, the communication link 806 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer readable medium 804 includes a set of computer readable instructions 808, which may be accessed by the processor 802 through the communication link 806 and subsequently executed for reconfiguring the data pipeline. The processor 802 and the non-transitory computer readable medium 804 may also be communicatively coupled to the computational model 106 and the data intelligence repository 108 over the communication link 806.

Referring to FIG. 8, in an example, the non-transitory computer readable medium 804 includes computer readable instructions 808 that may cause the processor 802 to receive a query comprising an input descriptor. As discussed in one example, the query may be received from an interactive interface, such as the interactive interface 500. The query may be received from the interactive interface in response to receiving the input descriptor on the interactive interface, as discussed above. For example, upon receiving the input descriptor, the interactive interface may generate the query that may comprise the received input descriptor. Such input descriptor may be received by the processor 802.

Further, the input descriptor may indicate a retrieval parameter for querying the data intelligence repository 108 to obtain and partition a set of relevant data from the data intelligence repository 108. The retrieval parameter may indicate at least one characteristic about one or more datasets to be retrieved from the data intelligence repository 108. For example, the retrieval parameter may indicate an identifier of a dataset, a nature of a dataset, or other relevant attributes that help identify and locate the dataset within the data intelligence repository 108.

The instructions 808 may further cause the processor 802 to identify, based on the retrieval parameter, a set of data tags from amongst a plurality of data tags available in the data intelligence repository 108. As discussed above, the data intelligence repository 108 may comprise the plurality of datasets 202, where each data set may have a data tag linked therewith. In one example, the data tags may indicate details or information about the data contained within the dataset with which they are linked, as discussed above.

Further, identification of the set of data tags may be based on semantic conformity between the retrieval parameter and the data tags available in the data intelligence repository, as discussed above. for example, the processor 802 may determine a semantic similarity score for quantifying a semantic conformity between the retrieval parameter and each of the plurality of data tags, compare the semantic similarity score with a threshold similarity score to identify the set of data tags, from amongst the plurality of data tags, semantically conforming with the retrieval parameter, and identify, based on the comparison, the set of data tags semantically conforming with the retrieval parameter, ad discussed above.

Further, the instructions 808 may further cause the processor 802 to obtain, from the data intelligence repository 108, the dataset linked with each data tag in the set of data tags. As discussed above, each data tag may be linked with a dataset available or stored in the data intelligence repository 108. Based on the data tag, the dataset corresponding to the data tag may be located within the data intelligence repository 108 and obtained from the data intelligence repository 108 by the processor 802. The dataset linked with each data tag in the set of data tags may collectively form the set of relevant data.

The instructions 808 may further cause the processor 802 to perform the adaptive data segmentation workflow for the set of relevant data, as discussed above. The adaptive segmentation workflow may be performed to partition the set of relevant data into one or more segments based on at least one of the prescribed computational data dimension threshold, the semantic relationship between datasets in the set of relevant data, and the data partitioning schema derived based on partitioning of datasets indicated by a set of records historically recorded.

As discussed above, in one example, each of the one or more segments may be derived by partitioning the set of relevant data based on the prescribed computational data dimension threshold. In another example, each of the one or more segments may be derived based on semantic distinctiveness between the datasets in the set of relevant data, as discussed above. Each derived segment may comprise semantically dissimilar datasets. Further, in another example, each of the one or more segments is derived by partitioning the datasets, in the set of relevant data, based on the data partitioning schema, as discussed above.

Further, the instructions 808 may further cause the processor 802 to generate a record generation signal to indicate the one or more segments comprising the datasets from the set of relevant data. As discussed above in one example, the processor 802 may cause rendering of the graphical user interface 502 or the processing panel 510 on the workstation 110 to indicate the one or more segments, where each of the one or more segments may comprise the dataset linked therewith based on the partitioning.

The instructions 808 may further cause the processor 802 to cause rendering of a graphical user interface to indicate a machine-readable file comprising the one or more segments. In one example, the processor 802 may cause rendering of the graphical user interface, such as the graphical user interface 600, to indicate the machine-readable file comprising the one or more segments. In one example, the machine-readable file may be the record 602, as discussed above, the machine-readable file may comprise the one or more segments and the datasets linked with each of the one or more segments.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system comprising:
a processor to:
receive a query signal indicating an input descriptor, wherein the input descriptor is indicative of a retrieval parameter for querying a data intelligence repository to service the query signal;
parse datasets available in the data intelligence repository to identify a set of relevant data based on the retrieval parameter, wherein the set of relevant data is identified by deriving at least one of semantic inference and contextual inference between the retrieval parameter and the datasets available in the data intelligence repository;
execute an adaptive data segmentation workflow for the set of relevant data, wherein the adaptive segmentation workflow is to manage distribution of the set of relevant data amongst one or more segments based on at least one of:
a prescribed computational data dimension threshold, wherein each of the one or more segments is derived by dividing the set of relevant data based on the prescribed computational data dimension threshold;
a semantic relationship between data in the set of relevant data, wherein each of the one or more segments is derived based on semantic distinctiveness between data in the set of relevant data, wherein each derived segment comprises semantically dissimilar data from the set of relevant data; and
a data partitioning schema derived based on partitioning of data indicated by a set of records historically recorded, wherein each of the one or more segments is derived by distributing the data, in the set of relevant data, based on the data partitioning schema; and
generate a record generation signal to indicate each of the one or more segments comprising data from the set of relevant data.

2. The system of claim 1, wherein the processor is to cause generation of a record comprising the one or more segments.

3. The system of claim 2, wherein the processor is to cause rendering of a graphical user interface to indicate the record with the one or more segments comprising data from the set of relevant data.

4. The system of claim 1, wherein the processor is to cause rendering of one or more interactable components for each of the one or more segments, the one or more interactable components comprising at least one of:
a first interactable component to receive positive feedback for a segment, the positive feedback indicating acceptance of data linked with that segment;
a second interactable component to receive negative feedback for a segment, the negative feedback indicating erroneous distribution of data linked with that segment; and
a third interactable component to receive a modification feedback for a segment, the modification feedback indicating a request for modifying the data linked with that segment.

5. The system of claim 4, wherein the processor is to cause generation of a modified record comprising a modified instance of the data linked with that segment.

6. The system of claim 1, wherein the processor is to cause rendering of an interactive interface, wherein the query signal is generated by the interactive interface in response to receiving the input descriptor indicating the retrieval parameter.

7. The system of claim 1, wherein the data intelligence repository stores a plurality of data tags, wherein each data tag has a dataset linked therewith and indicates at least one characteristic about that dataset.

8. The system of claim 7, wherein, to identify the set of relevant data from the datasets available in the data intelligence repository, the processor is to:
determine semantic conformity between the retrieval parameter and each of the plurality of data tags;
identify a set of data tags from amongst the plurality of data tags semantically conforming with the retrieval parameter; and
identify the dataset linked with each data tag in the set of data tags, wherein the identified datasets collectively form the set of relevant data.

9. The system of claim 8, wherein the processor is to:
compute a semantic similarity score for quantifying a semantic conformity between the retrieval parameter and each of the plurality of data tags;
compare the semantic similarity score with a threshold similarity score to identify the set of data tags, from amongst the plurality of data tags, semantically conforming with the retrieval parameter; and
identify, based on the comparison, the set of data tags semantically conforming with the retrieval parameter.

10. A method comprising:
receiving a query comprising an input descriptor, wherein the input descriptor is indicative of a retrieval parameter for querying a data intelligence repository to retrieve a set of relevant data from the data intelligence repository;
identifying, based on the retrieval parameter, a set of data tags from amongst a plurality of data tags available in the data intelligence repository, wherein the set of data tags is identified based on semantic conformity between the retrieval parameter and each of the plurality of data tags, and wherein the data intelligence repository stores a plurality of datasets, each having a data tag, from amongst the plurality of data tags, linked therewith;
retrieving, from the data intelligence repository, the dataset linked with each data tag in the set of data tags, wherein the dataset linked with each data tag in the set of data tags collectively forms the set of relevant data;
partitioning the set of relevant data into a plurality of segments based on at least one of:
a prescribed computational data dimension threshold, wherein each of the plurality of segments is derived by partitioning the set of relevant data based on the prescribed computational data dimension threshold;
a semantic relationship between datasets in the set of relevant data, wherein each of the plurality of segments is derived based on semantic distinctiveness between the datasets in the set of relevant data, and wherein each derived segment comprises semantically dissimilar datasets; and
a data partitioning schema derived based on partitioning of datasets indicated by a set of records historically recorded, wherein each of the plurality of segments is derived by partitioning the datasets, in the set of relevant data, based on the data partitioning schema; and
causing rendering of an indication of the plurality of segments comprising the datasets from the set of relevant data.

11. The method of claim 10, wherein the method further comprises causing rendering of a graphical user interface to indicate a record to represent the plurality of segments comprising the datasets from the set of relevant data.

12. The method of claim 11, wherein the method further comprises causing rendering of one or more interactable components on the graphical user interface for each of the plurality of segments, the one or more interactable components comprising at least one of:
a first interactable component to receive positive feedback for a segment, the positive feedback indicating acceptance of dataset linked with that segment;
a second interactable component to receive negative feedback for a segment, the negative feedback indicating erroneous partitioning of dataset linked with that segment; and
a third interactable component to receive a modification feedback for a segment, the modification feedback indicating a request for modifying the dataset linked with that segment.

13. The method of claim 12, wherein the method further comprises causing generation of a modified record comprising a modified instance of the dataset linked with that segment.

14. The method of claim 10, wherein the query is received from an interactive interface, wherein the query is generated by the interactive interface in response to receiving the input descriptor.

15. The method of claim 10, wherein the method further comprises:
computing a semantic similarity score for quantifying a semantic conformity between the retrieval parameter and each of the plurality of data tags;
comparing the semantic similarity score with a threshold similarity score to identify the set of data tags, from amongst the plurality of data tags, semantically conforming with the retrieval parameter; and
identifying, based on the comparison, the set of data tags semantically conforming with the retrieval parameter.

16. A non-transitory computer-readable medium comprising instructions being executable by a processing resource to:
receive a query comprising an input descriptor, the input descriptor indicating a retrieval parameter for querying a data intelligence repository to obtain and partition a set of relevant data from the data intelligence repository;
identify, based on the retrieval parameter, a set of data tags from amongst a plurality of data tags available in the data intelligence repository, wherein the set of data tags is identified based on semantic conformity between the retrieval parameter and each of the plurality of data tags, and wherein the data intelligence repository stores a plurality of datasets, each having a data tag, from amongst the plurality of data tags, linked therewith;
obtain, from the data intelligence repository, the dataset linked with each data tag in the set of data tags, wherein the dataset linked with each data tag in the set of data tags collectively forms the set of relevant data;
perform an adaptive data segmentation workflow for the set of relevant data, wherein the adaptive segmentation workflow is to partition the set of relevant data into one or more segments based on at least one of:
a prescribed computational data dimension threshold, wherein each of the one or more segments is derived by partitioning the set of relevant data based on the prescribed computational data dimension threshold;
a semantic relationship between datasets in the set of relevant data, wherein each of the one or more segments is derived based on semantic distinctiveness between the datasets in the set of relevant data, and wherein each derived segment comprises semantically dissimilar datasets; and
a data partitioning schema derived based on partitioning of datasets indicated by a set of records historically recorded, wherein each of the one or more segments is derived by partitioning the datasets, in the set of relevant data, based on the data partitioning schema; and
generate a record generation signal to indicate the one or more segments comprising the datasets from the set of relevant data.

17. The non-transitory computer-readable medium of claim 16, wherein the instructions are executed by the processing resource to cause rendering of a graphical user interface to indicate a machine-readable file comprising the one or more segments.

18. The non-transitory computer-readable medium of claim 16, wherein the retrieval parameter indicates at least one characteristic about one or more datasets to be retrieved from the data intelligence repository.

19. The non-transitory computer-readable medium of claim 16, wherein the instructions are executed by the processing resource to cause rendering of an interactive interface, wherein the query is received from the interactive interface in response to a submission of the input descriptor on the interactive interface.

20. The non-transitory computer-readable medium of claim 16, wherein the instructions are executed by the processing resource to:
determine a semantic similarity score for quantifying a semantic conformity between the retrieval parameter and each of the plurality of data tags;
compare the semantic similarity score with a threshold similarity score to identify the set of data tags, from amongst the plurality of data tags, semantically conforming with the retrieval parameter; and
identify, based on the comparison, the set of data tags semantically conforming with the retrieval parameter.
